(19) United States
(12) Patent Application Publication
(10) Pub. No.: US 2025/0060159 A1
(43) Pub. Date: Feb. 20, 2025

(54) DEVICE AND METHOD FOR FREEZE-DRYNG LIQUID-CONTAINING COMPOSITION

(71) Applicant: RHEAVITA BV, GENT (BE)

(72) Inventors: Jozef Antonius Willem Maria CORVER, NUENEN (NL); Menno Cornellis BOUHUIJS, HENGELO (NL); Michel PRIJS, VROOMSHOOP (NL)

(73) Assignee: RHEAVITA BV, GENT (BE)

(21) Appl. No.: 18/723,475

(22) PCT Filed: Dec. 21, 2022
(86) PCT No.: PCT/EP2022/087383

§ 371 Date: Jun. 24, 2024

(30) Foreign Application Priority Data
Dec. 22, 2021 (NL) 2030238
Dec. 22, 2021 (NL) 2030239
Dec. 22, 2021 (NL) 2030240
Dec. 22, 2021 (NL) 2030241
Dec. 22, 2021 (NL) 2030242

(51) Int. Cl. F26B 5/04; F26B 5/06; F26B 15/12; F26B 25/00

(52) U.S. Cl. CPC F26B 5/042; F26B 5/06; F26B 15/12; F26B 25/003

(57) ABSTRACT

The invention relates to a device for freeze-drying a liquid-containing composition, including but not limited to injectable compositions, in particular pharmaceutical compositions, biological compositions, cosmetic compositions or medical nutritional products. In particular, the present disclosure relates to a device suitable for freeze-drying liquid-containing compositions in a continuous process and to methods therefore. The device for freeze-drying a liquid containing composition in a continuous process comprises one or more, preferably three or more, of a spinner, a transportation mechanism, a vial handler, a vacuum door, and a stoppering system.

### TECHNICAL FIELD

This disclosure relates to the field of freeze-drying of liquid-containing compositions, including but not limited to injectable compositions, in particular pharmaceutical compositions, biological compositions, cosmetic compositions, or medical nutritional products. In particular, the present disclosure relates to a device suitable for freeze-drying liquid-containing compositions in a continuous process and to methods therefore.

### BACKGROUND

Freeze drying, also known as lyophilisation, is a technique to remove liquid such as water from a composition after the composition is frozen and placed under a vacuum, such that the frozen liquid can be removed by sublimation. Sublimation is the transition of a composition directly from a solid state into a gas state, without passing through a liquid state. Freeze drying has been known for decades and used typically on perishable material (e.g. pharmaceutical products or food products), for example to make the material more convenient for storage, distribution and/or transport.

A conventional method to execute this lyophilisation process is to place a batch of containers, such as vials, each container provided with a dispersion of a composition, on hollow shelves inside a sealed chamber. With a thermal fluid flowing through the hollow shelves, the shelves are chilled which in turn reduces the temperature of the containers and the composition inside. At the end of this freezing cycle the aqueous composition is frozen as a plug at the bottom of the container, after which the pressure in the chamber is reduced and the shelves are simultaneously gradually heated to force sublimation of ice crystals formed in the frozen composition. During the sublimation process vapour, preferably water vapour, will be generated which leaves the surface of the plug. The ice-vapour interface, also called the sublimation front, moves slowly downward as the sublimation process progresses. Once a substantial part of the ice crystals has been removed a porous structure of the composition remains. Commonly, a secondary drying step will follow to complete the lyophilization cycle wherein some, but generally not all, residual moisture is removed from the formulation interstitial matrix by desorption. The temperature of the composition increases to room temperature during the process.

Such known batch processes suffer from various drawbacks, in particular relating to the quality of the final freeze-dried product. The freezing step is one of the steps that is considered critical for the quality of the final dried product, since the structure and morphology of the consequential dried product is established in this step. In batch processes, neither the freezing step, nor the sublimation step can be accurately monitored or individually controlled, leading to variations in the process per individual vial.

Document WO 2018/033468 A1 addresses such problems and provides a method of drying a frozen product stored in a container, wherein a thermal IR image of the container wall using a thermal IR camera is used to calculate the a maximum temperature of the product in the container and to control the amount of power supplied to the container based on the calculated maximum temperature. Here, the vials are spun to form a dispersion layer on an inner surface of the vial to increase the control of the temperature during the first heating step.

In “Evaluation of spin freezing versus conventional freezing as part of a continuous pharmaceutical freeze-drying concept for unit doses”, L. De Meyer et al. compare the sublimation rate of spin-frozen vials versus traditionally frozen vials in a batch freeze-drying, explaining advantages associated with spin-freezing vials.

However, problems remain with respect to the development of a device capable of providing a continuous freeze-drying process with a substantial throughput, obeying GMP requirements, which is able to produce products in line with the requirements of for example the pharmaceutical industry. In particular, problems still arise with the formation of a homogeneous dispersion layer and heating thereof, while maintaining a continuous operation of the freeze-drying process. Furthermore, problems still arise with respect to particle formation, which may contaminate the product, leading to a degradation of quality of the end-product.

It is therefore and object of the present invention to solve one or more of the abovementioned problems relating to freeze-drying a liquid-containing compositions in a continuous process.

### DESCRIPTION OF THE INVENTION

To address one or more of the above discussed drawbacks of the prior art, the present invention provides a device for freeze-drying a liquid-containing composition in a continuous process, wherein the liquid-containing composition is provided in a plurality of vials, wherein the device comprises at least one of: (i) a spinner according to any embodiment described hereinbelow; (ii) a transport mechanism according to any embodiment described hereinbelow; (iii) at least one vacuum door according to any embodiment described hereinbelow; (iv) at least one vial handler according to any embodiment described hereinbelow; (v) at least one stoppering system according to any embodiment described hereinbelow.

The provision of such a device increases the efficiency of the continuous freeze-drying process by e.g. increasing one or more of: the homogeneity of the dispersion layer, the sublimation thereof, the heating thereof, and (simultaneously) keeping the amount of particles that the liquid-containing composition is exposed to at a very low level. As such, the quality of the composition upon freeze-drying is at very high level, allowing a full GMP process with equipment that can handle at least 500 vials per day, typically 5000 vials per day or more by adding modular elements. GMP processing further requires cleaning and sterilization of the equipment, and the present invention also provides solutions to sterilisation in a way that efficiently and reliably allows cleaning and sterilisation, while limiting particle development.

### (i) Spinner Design

It is preferable to spin the vial containing said liquid-containing composition, in particular for the subsequent sublimation step. If the vial is not spun during freezing, the liquid-containing composition is gathered in the bottom part of the vial, having a relatively high, non-uniform, thickness because of the generally concave meniscus of water based liquids in glass or plastic containers. This makes uniformly freezing and subsequently sublimating the liquid-containing composition difficult. In embodiments using spin-freezing, the vial preferably has a substantially cylindrical shape. The vial is then spun along its longitudinal axis, which is substantially parallel to the direction of gravity. As a result, a thin dispersion layer is formed on its inner surface. The formation of a thin dispersion layer on the inner surface of the vial results in a more uniform heat transfer from the exterior surface of the container to the inside of the container and the liquid-containing composition. As a result, during the first drying step, the sublimation of the liquid in the liquid-containing composition can be more precisely controlled. The homogeneous thickness of the dispersion layer reduces the differences of sublimation between various points in the vial.

The faster the vial is spun, the more uniform the thin dispersion layer is formed on the inner surface of the vial. This is due to the relationship between the centrifugal forces due to the spinning of the vial and the gravitational forces acting on the liquid-containing composition. If the vial is spun slowly, the liquid-containing composition will attain a paraboloid or a truncated paraboloid cross-sectional shape over a section or the entire height of the vial. As the vial is spun faster, the liquid-containing composition will form a dispersion layer, having a thickness which decreases from a high thickness on a bottom section of the vial to a lower thickness on a top section of the vial. That is, the dispersion layer will have a non-constant thickness over the height of the vial. If the vial is spun even faster, the dispersion layer will become substantially homogeneous over the height of the vial. That is, the centrifugal forces on the liquid-containing compositions will become sufficiently high to counteract a large proportion of the effects of gravitational forces on the liquid-containing composition.

To achieve increased rotational velocities, without risk of the vial being released, the vial must be clamped. A spinner generally has a support upon which the vial is placed and a clamping mechanism for maintaining the position of the vial on the support. Known clamping mechanisms utilize a spring-loaded system, which clamps the vial in a predetermined position with a spring-force. These clamping mechanisms generally comprise a plurality of arms. At least one of the arms is rotationally mounted to the support and arranged in a biased position towards the other arms by a spring. As the vial is provided in such a clamping mechanism, the arms grip the vial with a force determined by the spring. When the vial is spun, the centrifugal forces which allow the formation of dispersion layer on the inner surface of the vial also act on the arms of the clamping mechanism, thereby reducing the force with which the vial is maintained on the support. Maintaining the vial in the optimal position is thus difficult as the rotational velocity of the clamping mechanism is increased.

If the rotational velocity of the clamping mechanism of the spinner is increased, maintaining the vial in a balanced position becomes increasingly difficult. At such speeds, it is important that the vial is kept in line with the rotational axis. If the vial is not maintained in this position, the rotation may lead to undesired unbalance of the vial, resulting in vibrations and possibly in release of the vial. The vibrations and unbalance lead to a decrease in the uniformity of the dispersion layer, which is highly undesirable.

An option would be to increase the spring force. However, this also has further drawbacks since the forces required to retract the arm for placement of the vial are greater. Furthermore, increasing the spring force may also damage the vial and add unbalance to the spinner. Making the clamping mechanism more robust further increases the total weight of the spinner, thereby increasing the kinetic energy of the system, and increasing the pull on the arms due to centrifugal forces.

Preferably, the device for freeze-drying a liquid-containing composition in a continuous process comprises a spinner arranged to spin the vial with a rotational velocity of at least about 2000 rpm, preferably with at least about 3000 rpm, more preferably with at least about 4000 rpm. In an embodiment, the spinner is arranged to spin the vial with a rotational velocity of between about 2000 and 7000 rpm, preferably with between about 3000 and 6000 rpm, more preferably with between about 3500 and 5000 rpm.

In an embodiment, the device for freeze-drying a liquid-containing composition in a continuous process comprises a spinner having a support for supporting the vial, and a clamping mechanism connected to the support, wherein the clamping mechanism comprises at least two arms coupled to the support, wherein at least one of the arms is a rotating arm being rotationally coupled to the support via a hinge, wherein the rotating arm comprises a top portion that clamps the vial when spinning and a bottom portion having a counterweight, said hinge being provided between said top portion and said bottom portion.

In an embodiment, all arms are rotating arms, being rotationally coupled to the support via a hinge. In another embodiment, one or more of the arms are fixed arms, which are statically coupled to the support. The spinner comprises at least one, possibly more rotating arms being rotationally coupled to the support via a hinge.

By providing a counterweight underneath the hinge, the reduction of the gripping force on the vial due to an increase of the rotational velocity can be prevented. The centrifugal forces acting on the rotating arm above the hinge decrease the gripping force on the vial. However, the centrifugal forces acting on the bottom part, below the hinge, increase the gripping force of the rotating arm on the vial. The total gripping force exerted by the gripping arms on the vial is dependent on the centrifugal forces on the bottom portion relative to the centrifugal forces on the top portion, and the distance of the centre of gravity of the bottom portion and top portion from the hinge. By providing a counterweight underneath the hinge, force exerted on a vial by e.g. a spring is counteracted to a lesser extent by the centrifugal forces acting on the top portion of the rotating arm.

In an embodiment, the gravitational centre of the rotating arm as a whole is positioned below the hinge. As such, the bottom portion is arranged to provide a greater moment around the hinge than the top portion as a result of the centrifugal forces, leading to an increased gripping force as the rotational velocity is increased. That is, the total moment created around the hinge due to the centrifugal forces acting on the rotating arm is greater for the bottom portion than the top portion. In particular, in this embodiment, the distance of the centre of gravity of the top portion to the hinge, multiplied by the weight of the top portion, is lower than the distance of the centre of gravity of the bottom portion to the hinge, multiplied by the weight of the top portion. The result is that the bottom portion is forced outward more than the top portion, creating an increasing gripping force on the vial by the bottom portion as the rotational velocity is increased. Even if the vial is not positioned directly in the centre of the support, the increased force provided by the rotating arm as the rotational velocity of the spinner increases, will push the vial to the centre position. As such, the problems associated with the desire of achieving a higher rotational velocity while keeping the vial stabilized on the support are reduced.

Absent any mechanical fastening means, such as e.g. a spring, there is no force exerted on the vial at the start of the rotation. In such an embodiment, at a certain rotational velocity, the rotation arm engages with the vial to stabilize the vial by pressing the vial against the fixed arms. To prevent the vial to slide off the support, which can only occur when the vial is initially placed in a non-optimal manner, the support is coated with a friction-inducing substance. In a preferred embodiment, the friction-inducing substance comprises silicone. Other friction-inducing substances which are accepted in pharmaceutical industry may also be used. In another embodiment, the frictional force is increased by adapting the surface structure of the support, e.g., by roughening the surface. In yet another embodiment, the support is adapted to the shape of the vial and provides a slide to adaptively align with the vial, e.g., with the bottom of the vial.

As the rotational velocity is increased, the force on the vial may increase. In particular, the distance of the centre of gravity of the rotating arm with respect to the hinge, and the rotational velocity of the spinner, taken together, influence the force applied on the vial. If the force on the vial is too high, the vial may be damaged. As such, the moment around the hinge, based on the centre of gravity and the weight, and the rotational velocity, is preferably limited to prevent damage to the vial.

In a preferred embodiment, the mass multiplied with the distance between the centre of gravity and the hinge of the bottom portion is more than 10% larger than the mass multiplied with the distance between the centre of gravity and the hinge of the top portion, preferably between 20-100% larger. As such, at increased rotational speeds, the moment created by the centrifugal force on the bottom portion is more than 10% larger than the moment created by the centrifugal force on the top portion. In a preferred embodiment, the moment created by the centrifugal force on the bottom portion is more than 20-100% percent larger, still more preferably 20-50% percent larger, than the moment created by the centrifugal force on the top portion. A higher difference in moment may cause forces on the vial which are too strong, thereby possibly damaging the vial. That is, the aggregated force of the top portion on the vial, resulting from the centrifugal forces acting on the top portion and the bottom portion, may be too high and thus damage the vial.

A suitable way to implement the difference in moment is to have the bottom portion be heavier than the top portion at a comparable length.

In a preferred embodiment, the rotating arm further comprises a spring element arranged to provide an initial gripping force to the rotating arm. By providing an additional spring, the force exerted by the rotating arm to the vial is not solely dependent on the rotational velocity of the spinner. This ensures that the vial is also stabilized when the rotational velocity is low or even zero. When the rotational velocity of the spinner is increased, the force exerted by the rotating arm to the vial is increased, thereby further stabilizing the vial on the support of the spinner.

In an embodiment, the rotating arm has a balanced position, when the spinner is stationary, wherein the bottom portion is slanted towards the support, while the top portion is slanted away from the support. As a result, the clamping mechanism opens when the rotation is stopped, so that the vials may be easily provided to the support or removed therefrom.

In a preferred embodiment, the clamping mechanism comprises two fixed arms. The use of two fixed arms further stabilizes the vial during rotation of the spinner. The spinner further comprises at least one rotating arm.

In an embodiment, each arm comprises a first and a second engagement point, said first engagement point being arranged to engage with the vial above its centre of gravity, and said second engagement point being arrange to engage with the vial below its centre of gravity. The engagement points are above and below the centre of gravity in relation to the axis of rotation. The use of two engagement points on either side of the centre of gravity along the axis of rotation leads to increased stability of the vial. As the rotational velocity is increased, the centre of gravity of the vial shifts upwards, as the liquid-containing composition moves from the bottom of the vial to the sides. This shift of the centre of gravity may cause the vial to become unstable, if it rises above all engagement points. By providing one engagement point below the centre of gravity, and one above, the vial remains higher stability once the liquid-containing composition forms the dispersion layer.

In another embodiment the clamping mechanism consists of three identical rotating arms arranged in such a way that at low rotational speed the vial cannot be released but at increasing speed provides the clamping force that is necessary to maintain the position of the vial. In this embodiment, the fixed arms are replaced by rotating arms. This may be advised in case the cylindricity of the vial is not guaranteed. In such a way the optimal homogeneity of the dispersion layer is achieved. This embodiment may have another advantage being applicable to multiple vial dimensions without the need for change-over to other formats.

In another related embodiment the top portion of the one or more rotating arms are slanted away when the spinner is stationary and the bottom parts are slanted towards the support. In this stationary situation the vial is easily removed and placed. To avoid undesired release of the vial during ramp up of the rotation speed, a lock can be added to the support that forces the counterweights in an outward direction prior to ramp up of the rotation speed. The lock can comprise a slidable element with a slanted top surface, that can slide upwards in the direction of the support, such that the slanted top surface engages the bottom parts. For example, the slidable element can move upwards along the axis of rotation underneath the support of the vial. Because of the slanted top surface of the slidable element, the bottom parts are engaged at their resting position. Due to the upward sliding movement of the slidable element, the bottom parts can be pushed in an outward direction towards a position slanted away from the rotation axis of the support such that the top portion of the one or more rotating arms engages or engages more with the vial. The sliding block may stay in the up position before and during the ramp up of the rotation. This may be achieved by modifying the axle to achieve sufficient frictional resistance. Another embodiment may apply magnetic force at the holding position. Yet another embodiment may contain a flexible element that prevents the sliding block from moving downwards, but which force may be overcome by an actuator. E.g., a pen-system, where the lock can be pushed over a pin that can be released in a stationary situation with a spring-like construction. Since the purpose is to avoid release of the vial during ramp-up or ramp-down, the lock system does not have to clamp the vial, but it can avoid release of the vial. In order to move the sliding block towards the up position or towards the down position a lever-mechanism, e.g., a lever arm, may be applied to engage the sliding block when the spinner is not rotating. Such lever-mechanism may contain fingers that may be moved away when the spinner is rotating. The lever arm with the fingers can rotate as to engage the fingers to the lock, then the lock moves up. The lever-mechanism rotates back so the lock is free to rotate with the axle, i.e., the lever-mechanism is not in contact with the lock during spinning of the vial. At the end of spinning, the lever-mechanism with the fingers rotates to engage the fingers with the lock. Finally, the lever-mechanism and lock moves down until the vial can be released from the one or more slanted arms.

In a preferred embodiment, the arms comprise at least one clamping block being releasably attached to the arm. The clamping blocks may comprise an engagement point. In a preferred embodiment, the first and second engagement points are provided by a first and second clamping block. The clamping blocks being releasably attached to the arms allows the spinner to be adaptable for use with different sizes of vials. As a result, only the clamping blocks must be replaced to maintain a vial having a different diameter in line with the rotational axis of the spinner.

In a preferred embodiment, the clamping blocks comprise a material arranged to limit Hertzian stress. Hertzian stress refers to the localized stresses that develop as two curved surfaces come in contact and deform slightly under the imposed loads. This amount of deformation is dependent on the modulus of elasticity of the material in contact. The vials are generally made from glass, having a typical Hertzian stress limit of between 44-77 MPa. The application of steel to grip the vials typically results in Hertzian stresses that exceed this limit. As a result, the use of steel for the clamping blocks may result in damage to the vials. On the other hand, there is a desire for sufficient mechanical stiffness, which is of particular importance to maintain the vial in position at higher rotational velocities. In a preferred embodiment, the clamping blocks comprise a coating of a material having a lower Hertzian stress. In an example embodiment, the clamping block comprises a high-stiffness material, such as a metal, preferably stainless steel, and a coating having a low Hertzian stress, such as PTFE. Generally, bare steel results in more than 10-fold higher Hertzian stress compared to PTFE. The use of a hybrid solution using a high-stiffness clamping block with a low-stiffness coating addresses both the desire for mechanical stiffness, as well as low Hertzian stresses between the clamping block and the vial.

In an alternative or additional embodiment, the entire support may be interchangeable to accommodate different sizes of vials. In such an embodiment, the support is releasably from the spinner, and may be replaced with a different support having different geometries. By virtue of providing an interchangeable support and/or by providing releasably attached clamping blocks to the arms, the spinner may be suitable for vials having a particular R-value (Rohr-value), which is associated with its dimensions. The spinner may be suitable for 2 R (Rohr) to 50 R (Rohr) vials. In a preferred embodiment, the spinner is suitable for vials with an R value of 10-20 R.

In an embodiment, the support comprises a flat top, preferably wherein the flat top is circular. In an embodiment, the flat top of the support comprises a silicone surface.

In an embodiment, the spinner may be surrounded by a chamber provided with one or more spray balls, said spray balls being arranged to provide water in liquid or gas form to the spinner. This facilitates cleaning and sterilisation between processing cycles and increases the quality of the freeze-dried product. Additionally, in a preferred embodiment, the spinner is actuated by a drive mechanism provided underneath the support, said drive mechanism being coupled to the support through a rotary axis. The drive mechanism is preferably arranged at a suitable distance from the vial opening by the rotary axis. As such, if particles are created by the drive mechanism, they are not close to the opening of the vial, thus improving the quality of the final product. In a further preferred embodiment, a permanent flow of air is directed in such a manner that particles generated near the drive mechanism are moved away from the vial opening. This may be done e.g. by providing a constant downward flow of air. This reduces the risk of particles ending up in the contents of the vial. In a yet further preferred embodiment, the section near the drive mechanism is shielded such that the flow of air cannot convectively disperse the generated particles. Particles may be generated a particle source such as for example a seal or bearing near or of the drive mechanism. The shield can for example be formed from stainless steel, PTFE, UHMPE and/or PEEK. Preferably, the shield has a rounded shape, e.g., a dome shape or umbrella shape, to achieve optimal flow of air least disturbed by the fast rotation of the axle. The dimensions of the shield can be such that the shield well extends over the dimensions of the particle source, such that the shield covers the direct air flow from the drive mechanism and the particle source towards the support. This further reduces the risk of particles ending up in the contents of the vial. This shield can be conveniently combined with the embodiment as described above where e.g. a lock comprising a slidable element is used to engage the counterweights in a manner that the vial is clamped in e.g. a stationary situation. For example, the shield provides a resting position for the slidable element when the slidable element does not engage the bottom parts of the one or more rotating arms. In another embodiment, the slidable element can be configured in such a manner that the bottom surface of the slidable element forms the shield.

### (ii) Transport Mechanism

It is desirable to homogeneously increase the temperature of the vials, after being frozen, such that the liquid-containing composition is at least in part sublimed. To homogeneously heat the vials, heat should be supplied to the entire circumference of the vial. This may be done by providing e.g. a heating jacket around the vial such as explained in e.g. WO2013/036107A2. However, such systems are not in conformity with the requirements of a continuous process. Putting a vial in a heating jacket or in a chamber having surrounding IR radiators severely hampers the continuous movement of the vial in a continuous freeze-drying process since the vial remains in the heating jacket or IR heating chamber until the sublimation and/or desorption process is complete. The vial in the jacket usually cannot be assessed by optical measurement systems thus hampering the possible feedback-controlled heating of the vial. There is thus a desire for a mechanism to heat a vial homogeneously without hampering the continuous process of the freeze-drying device and further allowing continuous optical measurement of the vial. Attempts have been made to move the vials while also rotating the vials in front of IR radiators. One of the known mechanisms pushes the vials onto rotating platforms, leading to increased development of particles. The development of particles is highly disadvantageous in aseptic enclosures. In addition, the vials are prone to instability, which may lead to toppling. As such, there is a desire for a mechanism allowing for transportation of the vials during heating, while allowing the vials to rotate without blocking the radiation energy from the IR radiators, without blocking optical measurement systems and while minimizing the production of particles.

In an embodiment, a transportation mechanism for use in a device for freeze-drying a liquid-containing composition in a continuous process is disclosed. The transportation mechanism can comprise two or more platforms for receiving vials and a walking beam. Said walking beam can comprise an elongated member having an at least partly open bottom surface. A cross-sectional shape of the elongated member can comprise two lateral projections on opposing sides of the at least partly open bottom surface, said projections being arranged to engage with a neck portion of the vial, said walking beam being arranged to move along a first vertical axis and along a second axis parallel to the elongated member to move at least one vial between the two or more platforms.

By providing such a transport mechanism, the vials may be moved from a first rotating platform to a second rotating platform in a continuous freeze-drying process without blocking radiation energy from e.g. IR radiators and/or optical measurement systems, while minimizing the production of particles. This allows uniform heating of the vials to increase the quality of the sublimation while also allowing the continuous process.

The lateral projections can extend along the entire length of the elongated member.

The at least partly open bottom surface can be defined by a recess of the elongated member extending over the entire length of the elongated member.

The elongated member can comprise two openings on opposing ends of the elongated member, suitable for admitting at least the to be engaged neck portion of the vial.

The two openings can be formed in the bottom surface and/or at least one of a side surface of the elongated member.

The lateral projections can be provided with a chamfered top surface.

The elongated member can be further provided with at least one opening on a top surface, such that an passage is defined through the elongated member, preferably wherein the at least one opening on the top surface is an elongated opening, extending over a width of a plurality of platforms and/or wherein the at least one opening on the top surface is formed by the elongated member comprising a plurality of small holes on the top surface.

The platforms can be provided with an upwardly directed rim along the periphery of the platform, preferably wherein the upwardly directed rim is composed of a plurality of upwardly directed projections or wherein the upwardly directed rim encircles the platform.

The walking beam can comprise two or more elongated members provided substantially parallel to each other.

The movement of the elongated member along the first vertical axis can be actuated by one or more lift motors and/or the movement of the elongated member along the second axis can be actuated by a crankshaft mechanism, preferably wherein the one or more lift motors can be provided underneath the crankshaft mechanism.

The platforms can be rotating platforms for rotating vials. The vials may be positioned on a first rotating platform, which slowly rotates the vial in front of a IR radiator to enhance the sublimation process. The words continuous heating with IR radiation, and/or continuous measuring the temperature of the content of the vial can be understood on the time scale of freeze drying (hours). Hence, rotating a vial such that the content is irradiated during a quarter of a minute every 1 or 2 minutes may be considered ‘continuous’. Equally, measuring the temperature every minute, or 5 minutes may be considered continuous.

The rotating platforms may be coupled to drive disks, wherein said drive disks are actuated by a belt, preferably wherein the drive disks comprise a peripheral recess for receiving the belt, more preferably wherein a single belt extends over all drive disks to rotate all rotating platforms at the same rotational velocity; and/or wherein said drive disks are actuated by magnetic couplings to rotate the rotating platforms, preferably wherein the magnetic drive is provided outside the location where the transportation mechanism is present, more preferably wherein sterilization or sanitization techniques are applied, even more preferably wherein vaporized hydrogen peroxide is employed.

In an embodiment of the invention a module is disclosed, wherein the module may be a sublimation and/or desorption module, comprising the transportation mechanism according to the previous embodiment of the invention, wherein the module may comprise an array of infrared radiators along a length of the module, preferably wherein the module may comprise infrared temperature sensors arranged to monitor the temperature of the part of the vials facing away from the infrared radiators, more preferably wherein the temperature sensors may be provided above the walking beam.

In an embodiment of the invention a device for freeze-drying a liquid containing composition in a continuous process is disclosed, said device comprising a transportation mechanism according to the transportation mechanism embodiment of the invention described above.

In an embodiment of the invention a method for transporting a plurality of vials is disclosed, each vial may be respectively transported at the same time from a start platform for that vial to an end platform for that vial, wherein the start platforms may be different for each vial and wherein the end platforms may be different for each vial, preferably wherein the end platform of a first vial may be the start platform of a second vial and/or wherein the platforms may be rotating platforms; the method may comprise: engaging with a neck portion of each vial at its start platform; performing an upward vertical movement of each vial; performing a horizontal movement of each vial, such that each vial is above its end platform; performing a downward vertical movement of each vial so that each vial is placed on its end platform; and disengaging with the neck portion of each vial at its end platform.

In an embodiment, the device for freeze-drying a liquid-containing composition in a continuous process comprises a transportation mechanism having two or more rotating platforms for receiving and rotating vials, and a walking beam, said walking beam comprising an elongated member having a recess extending over the entire length of the elongated member, wherein said recess defines two openings on opposing ends of the elongated member, and said recess further defining an open bottom surface of the elongated member, and wherein a cross-sectional shape of the elongated member comprises two lateral projections on opposing sides of the open bottom surface, said projections being arranged to engage with a neck portion of the vial, said walking beam being arranged to move along a first vertical axis and along a second axis parallel to the elongated member to move at least one vial between the two or more rotating platforms.

By providing such a transport mechanism, the vials may be moved from a first rotating platform to a second rotating platform in a continuous freeze-drying process without blocking radiation energy from the IR radiators and optical measurement systems, while minimizing the production of particles. This allows uniform heating of the vials to increase the quality of the sublimation while also allowing the continuous process. Once the vials are provided to the sublimation module, the vials may be positioned on a first rotating platform, which slowly rotates the vial in front of a IR radiator to enhance the sublimation process. The words continuous heating with IR radiation, and/or continuous measuring the temperature of the content of the vial has to be understood on the time scale of freeze drying (hours). Hence, rotating a vial such that the content is irradiated during a quarter of a minute every 1 or 2 minutes may be considered ‘continuous’. Equally, measuring the temperature every minute, or 5 minutes may be considered continuous.

The vials are moved throughout the sublimation module along at least two, preferably at least 5, more preferably at least 10 rotating platforms. The opening in the first end of the elongated member is provided around the neck portion of the vial by moving the elongated member along the second axis, parallel to the elongated member. This provides the neck portion of the vial in the recess of the elongated member. The lateral projections of the elongated member do not engage with the neck portion of the vial yet. Once the vial needs to be moved to the second rotating platform, the elongated member is moved along the vertical axis to lift the vial from the first rotating platform. The lateral projections engage with the neck portion of the vial once the elongated member is moved upwards. Once the vial is lifted from the first rotating platform, the elongated member is moved along the second axis again, now in the opposite direction, to move the vial towards the second platform. Once the vial is positioned above the second rotating platform, the elongated member is moved downward along the first vertical axis to position the vial on the second rotating platform and to disengage the projections from the neck portion of the vial. The elongated member may then be moved along the second axis again, which may provide the opening in the first end of the elongated member around the neck portion of the next vial. Now, the neck portions of both vials are provided in the recess, with one vial on the first rotating platform and one vial on the second platform. To move both vials to a next rotating platform, the process is repeated. The vials are lifted and positioned on the next rotating platform.

The use of an elongated member having a recess with lateral projections to engage with the neck of the vial allows the vials to be moved between rotating platforms without the production of particles and without blocking the radiation from IR radiators. Furthermore, by providing an elongated member having an elongated recess, the elongated member may move multiple vials at once.

By lifting the vials by the neck portion, the risk of accidentally toppling the vials is largely precluded. Furthermore, as the vials are not gripped or otherwise engaged on section of the vial where the dispersion layer is present, the sublimation process is made more homogeneous.

In a preferred embodiment, the lateral projections are provided with a chamfered top surface. This may aid in self-alignment of the vial as it allows the vial to attain a balanced position within the recess of the elongated member of the walking beam.

In a preferred embodiment, the elongated member is further provided with at least one opening on a top surface, such that an passage is defined through the elongated member. By providing such an opening defining a passage, sublimed vapour from the liquid-containing substance can flow upward, without being trapped in the elongated member. In a preferred embodiment, the at least one opening on a top surface is an elongated opening, extending over a width of a plurality of vials. In an alternative embodiment, the elongated member comprises a plurality of small holes on the top surface to allow the vapour to pass through the elongated member.

In a preferred embodiment, the rotating platforms are provided with an upwardly directed rim along the periphery of the rotating platform. The upwardly directed rim may be composed of a plurality of upwardly directed projections. Alternatively, the upwardly directed rim may be provided continuously around the periphery of the rotating platform. The provision of an upwardly directed rim allows for increased stability of the vial on the rotating platform. Since the vials are lifted from the rotation platforms, rather than being pushed off, it is possible to provide such an upwardly directed rim along the periphery of the rotating platform.

In an embodiment, lateral projections extend continuously along the entire length of the elongated member.

In a preferred embodiment, the rotating platforms are coupled to drive disks, said drive disks being actuated by a belt. In an embodiment, a single belt extends over all drive disks to rotate all rotating platforms at the same rotational velocity.

In a preferred embodiment, the drive disks comprise a peripheral recess for receiving the belt. This limits the possibility of the belt slipping out of the drive disk.

In another embodiment the drive disks are actuated by magnetic couplings to rotate the rotating platforms. The advantage of such an embodiment is that less mechanical parts are present in the chamber as the magnetic drive is provided outside of the chamber. To actuate the drive disks, strong magnets are required, which tend to be susceptible to elevated temperatures which may occur during e.g. steam sterilization. The application of other sterilization or high-level sanitization techniques such as the use of vaporized hydrogen peroxide may be employed to mitigate the temperature susceptibility.

In another embodiment, the drive disks are shaped to match variable vial dimensions thereby avoiding the need for change-over when different vial sizes are implemented. In such a design for example the smallest vials would be deeper in the device, while the larger vials could stay on top of the drive disk. The design may be such that this construct is as ‘open’ as possible to allow maximum direct radiative access for the smallest vials. This can be implemented by using for example at least three poles with a stepped profile, so that each step of the profile accommodates a different vial size and to assure positional stability. A stepped disc can also be used.

In a preferred embodiment, the movement of the elongated member along the second axis is actuated by a crankshaft mechanism. In a further preferred embodiment, the movement of the elongated member along the first vertical axis is actuated by lift motors provided underneath the crankshaft mechanism. The crankshaft mechanism can transfer a rotary movement of the motor drive into a translational movement. Applying such a rotary actuation is for example optimal for interaction with vacuum systems and this also reduces the generation of particles.

In an embodiment, the walking beam comprises two or more elongated members, provided substantially parallel to each other. By providing the walking beam with two or more elongated members in parallel fashion, the throughput of the continuous freeze-drying device is increased.

In a preferred embodiment, the transportation mechanism is provided in a sublimation module and/or a desorption module. The sublimation module comprises an array of IR radiators along a length of the sublimation module. The desorption module also comprises an array of IR radiators along a length of the desorption module.

In an embodiment, infrared temperature sensors are provided above the walking beam, on a top section of the sublimation module, said infrared temperature sensors being arranged to continuously monitor the temperature of the vials facing away from the IR radiators.

(iii) Vacuum Doors

Separate regions of the device for freeze-drying a liquid-containing composition require different pressure regimes. Particularly, in continuous freeze-drying devices, it is preferable that different regions may be maintained at a vacuum, at atmospheric pressure, or for example at 1.5 bar overpressure conditions, used for sterilisation. To move vials from one region having a first pressure, to a second region, having a second pressure different from the first pressure, it is preferred to use a so-called load lock, having vacuum doors. Such a load lock comprises a transportation section, for moving the vials, and two vacuum doors, which are capable of providing a seal between two regions of the device for freeze-drying a liquid-containing composition having different pressures. The load lock is capable to have a varying pressure within the transportation section. Furthermore, for aseptic operations, it is necessary that the inner part of the vacuum doors can be fully cleaned and that the vacuum doors are capable of withstanding the pressure and temperature associated with clean steam of about 125° C.

Vacuum doors are known from for example the semiconductor industry. Although these vacuum doors have been designed to produce very low amounts of particles, they have not been designed to handle the pressure differentials required in freeze-drying processes. Furthermore, the known vacuum doors are not designed to withstand rigorous cleaning and sterilization procedures, which are required to attain continuous quality (in particular sterile character) of the freeze-dried product. It is noted that the term vacuum is understood to encompass general under-pressure relative to atmospheric pressure.

In an embodiment, the device for freeze-drying a liquid-containing composition further comprises a load lock, wherein the load lock comprises a transportation section comprising at least two vacuum doors, a first vacuum door being provided on a first side of the transportation section and a second vacuum door being provided in a second side of the transportation section, and said load lock further comprising at least two vial handlers, said vial handlers being arranged to move vials through the vacuum doors. In an embodiment, the transportation section comprises a platform provided on guide rails, said platform being arranged to move vials between the first side of the transportation section and the second side of the transportation section. In an embodiment, the vial handlers are in accordance with any of the embodiments provided hereinbefore.

In an embodiment, the vacuum door of the load lock may be used separately, in other regions of the freeze-drying device, separately from the load lock.

In an embodiment, the device for freeze-drying a liquid-containing composition in a continuous process comprises at least one vacuum door, having a first and a second opposing panel, defining a space therebetween, said two opposing panels having at least one opening, the opening of the first panel being located opposite the opening of the second panel, such that a vial can be passed through the openings to move through the vacuum door, wherein at least one sealing door is provided in the space defined by the opposing panels, said sealing door being moveable between a first position wherein the sealing door is positioned in front of the openings, and a second position, wherein the sealing door is positioned away from the openings, the vacuum door further comprising an actuation mechanism for actuating the sealing door, said actuation mechanism being arranged to move the sealing door towards the first opening or towards the second opening, when the sealing door is in the first position.

The provision of such a vacuum door allows for closing and opening the vacuum door while limiting the amount of particles. In particular, the provision of an actuation mechanism for actuating the sealing door allows for movement of the sealing door between the first and second positions without sliding along the first or the second panel, or a seating area of the openings in the panels. Once the sealing door is provided in the first position, in front of the openings in the opposing panels, the actuation mechanism may push the sealing door towards the opening in the first panel or towards the opening in the second panel. When the actuation mechanism does not engage with and/or actuate the sealing door, the sealing door may be provided freely in the space defined by the opposing panels. As a result of such an arrangement, the vacuum door may be closed or opened while limiting particle production.

Furthermore, as the actuation mechanism is arrange to move the sealing door towards the first opening or towards the second opening, when the sealing door is in the first position, the sealing door may close the opening in the panel which is most beneficial for a closely maintained seal. For example, if the first panel is provided on a side having atmospheric pressure, while the second panel is provided on a side having a vacuum pressure, it is preferable to actuate the sealing door towards the opening in the second panel. This is because the pressure differential between the atmospheric pressure and the vacuum provides a net pressure directed towards the region on the side of the second panel. Achieving an optimal seal between the sealing door and the opening in the first or the second panel may thus be aided by actuating the sealing door towards the low-pressure side of the vacuum door. Such an arrangement reduces leakage of the vacuum door and increases the control on the pressure in two regions which are separated by the vacuum door. This arrangement also facilitates a quick change of pressure in the load lock and therefore optimizes the system throughput.

In an embodiment, the sealing door comprises two peripheral seals provided on a first and a second side of the sealing door, said peripheral seals being arranged to engage with an seat region of the openings provided around the periphery of the openings. In a preferred embodiment, the seals are flexible. By providing peripheral seals to the doors, leakage may be further prevented. Small unevenness in either the opening or the door may be corrected by the flexible nature of the seals.

In a preferred embodiment, the vacuum door further comprises a pneumatic cylinder provided in the space defined by the two opposing panels, said pneumatic cylinder comprising a bellows provided around at least a part of a rod, said rod being attached to the sealing door, wherein the pneumatic cylinder is arranged to move the sealing doors between the first and second position. The connection between the rod and the sealing door may be direct or indirect. The provision of a pneumatic cylinder comprising a bellows positioned around at least a part of a rod shields the surrounding space from particles produced by movement of the rod within the pneumatic cylinder. In an embodiment, the pneumatic cylinder is provided below the sealing doors, such that the movement between the first and second position of the sealing doors is in a vertical direction.

In an alternative embodiment, the movement of the sealing doors between the first and the second positions, is actuated by a spindle mechanism, surrounded by a bellows.

In a preferred embodiment, the vacuum door further comprises at least one sealing door guide, provided in a lateral region of the vacuum door, such that the sealing door guide is arranged to guide sealing door from the first position to the second position. By providing sealing door guides, the movement of the doors between a first and second position is stabilized, thereby limiting possible vibrations, and thus limiting the production of particles.

In an embodiment, the actuation mechanism comprises at least one bellows actuator, provided in the first or second panel, arranged to engage with the rod to move the sealing door towards the opening in the first or the second panel. In an embodiment, a bellows actuator comprises a circular membrane, having an engagement surface provided in the middle of the membrane, wherein the membrane is arranged to project outwardly such that the engagement surface is moved outwardly. If the sealing door is provided in front of the openings in the first and second panel, the outward projection of the membrane moves the engagement surface towards the rod, thereby pressing the sealing door against the opposite opening. In a preferred embodiment, the actuation mechanism comprises at least two bellows actuators, provided in the first and second panel.

In a preferred embodiment, the engagement surface of the membrane engages with a distal end of the rod, said distal end of the rod being provided above an attachment point between the rod and the sealing door. By exerting a force to a distal end of the rod, the force required to press the sealing door against the opening is lessened.

In a preferred embodiment, the vacuum door further comprises a plurality of spray nozzles, arranged to provide a cleaning agent to the space defined by the opposing panels. The spray system can also be accompanied by draining lines to facilitate removal of fluids by gravity. The spray nozzles can be arranged such that all surfaces are reached by the jets of fluid. The design can be such that no pools of fluid remain after draining the door, for example by making sure that one or more bottom surfaces must have a slope which is at least 5 mm/m, preferably 10 mm/m, more preferably 20 mm/m so that any fluids can be drained by gravitation. Additional to cleaning with solutions of detergents in warm water of about 60° C., the spray nozzles may also disperse clean steam of about 125° C. for achieving sterile conditions as required for pharmaceutical application.

### (iv) Vial Handler

During the process of freeze-drying the liquid-containing composition, the vials are moved between regions of the device for freeze-drying a liquid-containing composition. In known systems, the vials are generally moved using a pushing system, which shifts the vials from a first location to a second location. By pushing the vials, the bottom of the vial drags over a surface, leading to increased particle production, which is highly disadvantageous to the quality of the final product. Furthermore, pushing the vials may lead to toppling of the vials, which is also highly disadvantageous to the quality of the freeze-drying process. It is thus desired to provide an improved vial handling system which addresses these drawbacks.

Existing solutions use highly complex gripping robots, which have multiple moving parts, leading to a complex system and to a higher degree of particle production. Furthermore, these often involve thermal contact with the side of the vial, influencing the temperature profile of the vial and/or the dispersion layer provided on the inner surface of the vial. Furthermore, the need for automated cleaning and sterilization using e.g. steam is not applicable to griping robots.

In an embodiment, the device for freeze-drying a liquid-containing composition in a continuous process comprises at least one vial handler, said vial handler having an elongated arm defining a distal end and a proximal end, said vial handler further comprising a gripper arranged to engage with a neck portion of a vial, said gripper being provided on the distal end of the elongated arm, wherein the elongated arm is provided through a barrier defining a pivot point, said pivot point being positioned between the distal end and the proximal end of the elongated arm such that actuation in a plane orthogonal to the elongated arm of the proximal end of the elongated arm on a first side of the barrier translates to an opposite movement of the distal end of the arm on a second side of the barrier.

When a vial is engaged by the gripper, an upward vertical movement may be executed by the gripper, which is provided on the distal end of the elongated arm, on the second side of the pivot point. This movement is actuated by a downward vertical movement of the proximal end of the elongated arm, on the first side of the pivot point. As the gripper is moved upwards, the gripper engages with the neck portion of the vial to lift the vial from its original position. The vial handler may then move the vial by extending the elongated arm through the barrier, moving the vial away from the barrier. The vial may also be laterally moved, by actuation of the proximal end of the elongated arm on the first side of the barrier in an opposite direction. Once the vial reaches its target location, the gripper is lowered to place the vial on the desired location, such as e.g. a process table, or e.g. a spinner support or a turning platform. When the vial is put down, the gripper disengages from the neck portion of the vial, allowing the gripper to be retracted by retracting the elongated arm.

Advantageously, the gripper engages with the vials at their neck portion, meaning that the section of the vial where the dispersion layer is present, need not be grabbed. As such, local heat transfer due to the handling of the vials is limited. Furthermore, since the actuation of the gripper is done on the first side of the barrier, particle production associated with said actuation does not occur in the same environment as the vial, thereby further increasing the quality of the freeze-drying process.

In an embodiment, the reach of the arm, along the direction of the arm, during extension of the arm, is at least about 150 mm, preferably at least about 200 mm, more preferably at least about 250 mm, still more preferably at least about 300 mm.

In a preferred embodiment, the gripper comprises two forwardly projecting legs, said legs having a reducing thickness moving away from the distal end of the arm, such that the legs define the gripper having an increasing width moving away from the distal end of the arm. In an embodiment, the reducing thickness of the legs is staggered, such the width of the gripper increases in a stepped manner. By providing a gripping with an increasing width, moving away from the distal end of the elongated arm, various sizes of vials may be gripped without changing the gripper. If a vial has a smaller neck portion, the gripper is moved further around the neck of the vial, where the increasing thickness of the legs towards the distal end of the elongated arm allows the vial to be gripped. Alternatively, if the vial has a thick neck portion, the gripper only needs to be provided around the neck portion of the vial to a lesser extent to grip the vial.

In a preferred embodiment, the elongated arm is provided in a bellows, said bellows being attached to the barrier and to the distal end of the elongated arm. By providing the elongated arm in a bellows, particle production resulting from extension and retraction of the elongated arm possibly reaching the vial is reduced.

In a preferred embodiment, the elongated arm has an elliptical shape to reduce deformation of the bellows when there is a pressure difference over the inside and outside of the bellows. This reduces wear of the bellows, since there is less deformation of the bellows at least along one axis of the elliptically shape of the elongated arm. Hence, the lifetime of the bellows is increased.

In another embodiment the elongated arm comprises a telescopic array of cylinders, which can protrude consecutively to extend the elongated arm. This may be advantageous to achieve a short structure that minimizes the equipment footprint.

In another embodiment the elongated arm comprises cylindrical elements that in retracted position of the elongated arm are wound in a chain-like fashion.

In a preferred embodiment, the vial handler further comprises at least one circular spray system, said circular spray system preferably being arranged around the elongated arm. In a preferred embodiment, the circular spray system is attached to the second side of the barrier. In an embodiment, the circular spray system is arranged around the bellows, and arranged to clean the bellows.

In another embodiment, the vial handler consists of an array of gripper elements to handle multiple vials at the same time. The vials can be taken by the neck. Since the position of gripper arms can be fixed with respect to each other, the positioning of the vials to be picked up has to be done at sufficient accuracy. Different mechanisms can be used for this, for example a combination of belt system with stops that engage when a vial needs to be in a fixed position, a screw system that moves one or more vials forward at fixed positions with respect to each other, and/or pick-and-place robots to put vials in a desired position.

### (v) Stoppering System

Once the product in the vial has been freeze-dried, the vial must be closed. Closing the vial may be done in multiple steps. In a first step, a primary closure is attained by the placement of a stopper on the vial. The stopper generally is made from a silicone rubber. This process is called stoppering. In known systems, stoppering is done by applying a vacuum to manipulate the stopper, by using a vacuum handling system, in order to place them on the vials. However, in a device for freeze-drying liquid-containing compositions, the use of a vacuum to manipulate the stopper is disadvantageous in case the environment is maintained at a low pressures. Maintaining reduced pressure is advantageous because the vials are in a sterile, closed chamber. In such case, it is very difficult to achieve the required pressure differential necessary for a vacuum handling mechanism to pick up the stoppers. There is thus a desire for a stoppering system which may be utilized in environments having low ambient pressures.

Existing solutions for stoppering the vials are to place the stopper on the vial without closing it prior to freeze-drying, which are pushed into the vial after ending the drying process. However, such an arrangement obstructs the vapour flow during sublimation and desorption and thus limits throughput of the freeze-drying device, thereby hampering production efficiency.

There thus still remains a desire for an improved stoppering system which allows for placement of the stoppers on the vials, which is operable under lowered pressures, and which limits the production of particles.

In an embodiment, the device for freeze-drying a liquid-containing composition in a continuous process comprises a stoppering system comprising a stopper holder being rotatably attached to a substantially horizontal actuation axis at a first end, said stopper holder being moveable between a receiving position and a stoppering position by the actuation axis, wherein the second end of the stopper holder comprises a slot at an edge region for receiving a stopper, said slot having a lateral shape to receive the stopper such that the stopper may be contained in the slot on a first side of the edge, and an opening for engaging the stopper with a vial on a second side of the edge, wherein in the receiving position the opening is directed upwards, and wherein in the stoppering position the opening is directed downwards, wherein the slot is formed such that the stopper is held in the slot in the stoppering position.

This allows the stoppers to be provided in the slot on one side of the actuation axis, while the vials to be stoppered are on the other side of the axis. The horizontal actuation axis rotates the stopper holder from the receiving position into the stoppering position, thereby turning the stopper upside down and providing the stopper to the vial. The horizontal actuation axis does not require to be completely horizontal and slight deviations are possible. The horizontal actuation axis should be positioned such that the stoppers do not fall from the stopper holder during normal operation.

Once the stopper is provided to the vial, the vial may be moved away, in the direction of the rotational axis, to withdraw the stopper, which is then provided in the vial, from the slot. This makes room for a new stopper to be provided to the stopper holder.

The stopper holder is then rotated back to the receiving position such that a new stopper can be provided to the slot.

In an embodiment, a flexible plate is provided on the stopper holder, said flexible plate being arranged over the opening defined by the slot, and said flexible plate having an opening corresponding with the opening defined by the slot, the opening on the flexible plate being smaller than the opening defined by the slot, such that the stopper is maintained in the slot. By providing a flexible plate, the stopper is kept in place during the movement of the stopper holder from the receiving position to the stoppering position, while allowing the stopper to be pressed into the vial in the stoppering position. The use of such a flexible plate allows slight deformation to press the stopper into the vial to an increased extent. In an embodiment, the flexible plate may be compressed as the stopper is pressed into the vial. As the stoppers are pressed into the vial further, the quality of the primary closure is increased.

In a preferred embodiment, the stopper holder further comprises a roller, arranged to engage the stopper when the stopper holder is provided in the stoppering position, such that the roller presses the stopper into the neck of the vial.

### (vi) Freeze Drying Device

Two or more of the embodiments described herein may be combined.

In an embodiment, there is provided a device for freeze-drying a liquid containing composition in a continuous process, said device comprising one or more, preferably three or more, of: a transportation mechanism according to any of the embodiments described herein; a vial handler according to any of the embodiments described herein; a vacuum door according to any of the embodiments described herein, preferably wherein the vacuum door forms part of a load lock according to the embodiments described herein; a spinner according to any of the embodiments described herein; and a stoppering system according to an of the embodiments described herein, preferably wherein the device comprises at least the transportation mechanism, the vial handler, and the vacuum door, more preferably wherein the device is able to process at least about 5000 vials per day.

In a more preferred embodiment, the present invention provides a device for freeze-drying a liquid containing composition in a continuous process comprising one or more of the above described embodiments, preferably two or more, and even more preferably three or more of the above described embodiments.

Particularly preferred is the combined use of embodiments (ii), (iii) and (iv) in a device for freeze-drying a liquid containing composition in a continuous process.

In a preferred embodiment, the device for freeze-drying a liquid containing composition in a continuous process is able to handle about 5000 vials per day or more.

The device for freeze-drying a liquid containing composition in a continuous process according the invention preferably provides control mechanism during freezing or drying step, allowing adjustment of freezing or sublimation speed. More preferably, both freezing and drying are controlled, such as described in WO2018/033468A1.

### BRIEF DESCRIPTION OF DRAWINGS

Embodiments will now be described, by way of example only, with reference to the accompanying schematic drawings in which corresponding reference symbols indicate corresponding parts, and in which:

FIG. 1 illustrates a perspective view of an embodiment according to the invention showing the device for freeze-drying a liquid-containing composition;

FIG. 2A-2D shows a spinner according to an embodiment of the invention provided in four stages wherein:

FIG. 2A shows a perspective view illustrating the stage where a vial is positioned on the support;

FIG. 2B shows a perspective view illustrating the vial after being positioned on the support;

FIG. 2C shows a frontal view illustrating the position the spinner and the vial at the start of rotation; and

FIG. 2D shows a frontal view illustrating the position of the spinner and the vial at the end of rotation;

FIG. 3A-3D shows a transportation mechanism according to an embodiment of the invention illustrating five steps of the transportation mechanism, in which:

FIG. 3A shows a frontal view illustrating the starting position of the transportation mechanism;

FIG. 3B shows a frontal view illustrating the upward vertical movement a walking beam, lifting the vials;

FIG. 3C shows a frontal view illustrating the horizontal forward movement of the walking beam bringing the vials to the next position;

FIG. 3D shows a frontal view illustrating the downward vertical movement, putting the vials on the rotating platforms; and

FIG. 3E shows a frontal view illustrating the horizontal backwards movement of the walking beam while leaving the vials in place;

FIG. 4 shows a transportation mechanism according to an embodiment of the invention, illustrating a drive mechanism generating a movement of the transport mechanism; where

FIG. 4A shows a top view illustrating the drive mechanism to move the lift frame in a horizontal direction; and

FIG. 4B shows a side view illustrating the drive mechanism which allows horizontal and vertical displacement of the transportation mechanism;

FIG. 5 shows a perspective view of the transportation mechanism according to an embodiment of the invention illustrating the free flow of vapour from vials provided in the transport mechanism;

FIG. 6 shows a side view of the transportation mechanism according to an embodiment of the invention illustrating self-alignment of the vial provided in the transport mechanism; where

FIG. 6A shows a side view illustrating the vial aligning itself along a vertical axis;

FIG. 6B shows a side view illustrating the vertically aligned vial in lifted position; and

FIG. 6C shows a side view illustrating the vial positioned on the rotating platform;

FIG. 7 shows a perspective view of a vacuum door according to an embodiment of the invention where:

FIG. 7A shows a perspective view showing the vacuum door;

FIG. 7B shows a cut-away view of the vacuum door, illustrating the inner parts of the vacuum door assembly;

FIG. 7C shows a cut-away view of the vacuum door, illustrating the process conditions during the cleaning process;

FIG. 8 shows a cross-sectional view of a vacuum door coupled to a load lock according to an embodiment of the invention where:

FIG. 8A illustrates a vacuum door coupled to a chamber having a higher pressure than the adjacent module; and

FIG. 8B illustrates a vacuum door coupled to a chamber having a pressure equal to the adjacent module;

FIG. 9 shows a perspective view of a vial handler according to an embodiment of the invention where:

FIG. 9A illustrates the vial handler in a retracted position; and

FIG. 9B illustrates the vial handler in an extended position;

FIG. 10 shows a side view of a vial handler according to an embodiment of the invention where:

FIG. 10A shows the vial handler in a retracted position without vertical displacement;

FIG. 10B shows the vial handler in an extended position without vertical displacement;

FIG. 10C shows the vial handler in a retracted position with downward vertical displacement;

FIG. 10D shows the vial handler in an extended position with downward vertical displacement;

FIG. 10E shows the vial handler in a retracted position with upward vertical displacement; and

FIG. 10F shows the vial handler in a retracted position with upward vertical displacement.

FIG. 11 shows a blow-out view of a gripper of the vial handler according to an embodiment of the invention, where:

FIG. 11A shows the gripper having a design with positions for two vial types;

FIG. 11B shows the gripper having a small vial in an engaged position; and

FIG. 11C shows the gripper having a large vial in an engaged position;

FIG. 12 shows a side view of a gripper of the vial handler according to an embodiment of the invention, where:

FIG. 12A shows the gripper having a large vial in an engaged position; and

FIG. 12B shows the gripper having a small vial in an engaged position;

FIG. 13 shows a perspective view of a stoppering system according to an embodiment of the invention, where:

FIG. 13A shows a feed of stoppers to a stopper holder in a receiving position;

FIG. 13B shows a rotation of the stopper holder from a receiving position to a stoppering position;

FIG. 13C shows the stopper holder in the stoppering position;

FIG. 14 shows a blow-out view of a stoppering system according to an embodiment of the invention, where:

FIG. 14A shows a stopper holder positioning a stopper near the neck of a vial;

FIG. 14B shows a stopper being pushed into the neck of a vial;

FIG. 14C shows the vial with the stopper being released from the stopper holder;

FIG. 15A-C shows spinners according to embodiments of the invention, comprising a lock and/or a shield; and

FIG. 16 shows the shield that covers the seal/bearing of the axle of the spinner.

The figures are intended for illustrative purposes only, and do not serve as restriction of the scope or the protection as laid down by the claims.

### Detailed Description of Illustrative Embodiments

Hereinafter, certain embodiments will be described in further detail. It should be appreciated, however, that these embodiments may not be construed as limiting the scope of protection for the present disclosure.

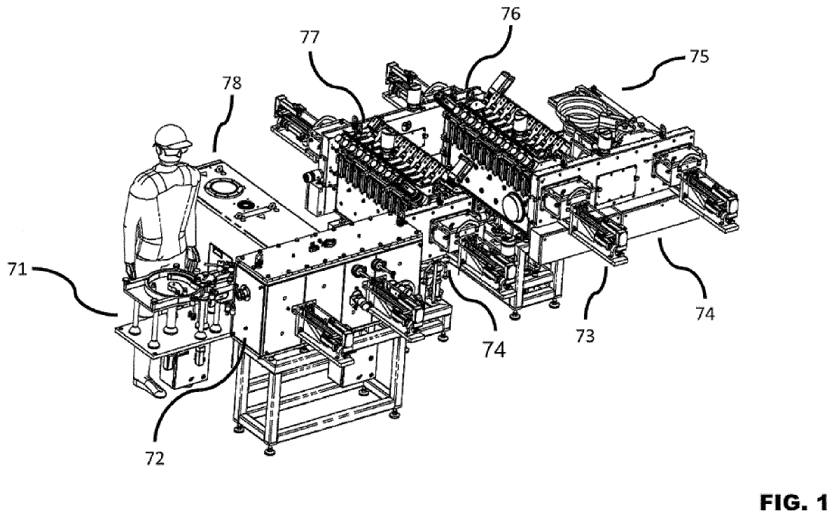

Referring to FIG. 1, a perspective view of an embodiment according to the invention is illustrated, showing the device for freeze-drying a liquid-containing composition. The shown embodiment shows an overview of the complete freeze-drying line from the stage where the vials are filled until the stage where the vials are stoppered. The illustrated embodiment shows an infeed and filling module 71, a spin-freezing module 72, a vial handler 73, a load-lock 74, a stoppering module 75, a desorption module 76, a sublimation module 77 and a vacuum pump 78. The infeed and filling module 71 is arranged to provide vials to the device for freeze-drying. Vials are provided to the infeed table of the infeed and filling module 71 and filled with an appropriate amount of liquid-containing composition. A vial handler 73 picks up the vials and introduces the vials into the spin-freeze module 72. The spin-freeze module 72 preferably comprises at least one module in accordance with an embodiment described herein and above under (i). In the spin-freeze module 72 the temperature is reduced to freeze the liquid-containing composition. When this process is finished, the vials are transferred into a load lock 74. The load lock 74 preferably comprises a transportation section and two vacuum doors. The pressure in the load lock 74 is at a pressure of the spin-freeze module 72. The first vacuum door is then opened, allowing the vials to be provided to the transportation section by the vial handler 73. The first vacuum door then closes, and the pressure inside the load lock is brought to substantially the same (reduced) pressure as the next module, which is the sublimation module 77. The vials are transported through the transportation section to the second vacuum door, and when the pressure in the load lock 74 is the same as the pressure in the sublimation module 77, the gate opens and the vials are moved into the sublimation module 77 by a vial handler 73. Preferably, the pressure inside the sublimation module 77 is a vacuum. For example, the pressure inside the sublimation module 77 below 100 Pa, preferably below 60 Pa, more preferably below 40 Pa, still more preferably below 10 Pa. After sublimation in the sublimation module 77, where the temperature of the vials is increased under a low pressure, the vials are transferred to a second load lock 74 in a similar manner as described above to move them to a desorption module 76. The pressure of the load lock 74 is adjusted in accordance with the pressure in the sublimation module 77, the vials are provided to the transportation section of the second load lock by the vial handler 73, the pressures are adjusted in accordance with the pressure of the desorption module 76. After proper adjustment of the vacuum pressure, the vials are provided to the desorption module 76 through the second load lock by the vial handlers 73. Generally, the pressure in the desorption module 76 is vacuum. For example, the pressure inside the desorption module 76 below 100 Pa, preferably below 60 Pa, more preferably below 40 Pa, still more preferably below 10 Pa. A transportation mechanism according to any of the embodiments described herein is preferably provided in the sublimation module 77 and/or the desorption module 76. When the desorption process of the liquid-containing composition is finished, the vials are transferred to a third load lock 74 to move them to a stoppering module 75. Again, the pressure in the load lock 74 is adjusted based on the desorption module 76 and the stoppering module 75 while moving the vials through the third load lock. In the stoppering module 75, the vials are provided with a stopper to seal the vial from the outer environment. After stoppering the process is finished.

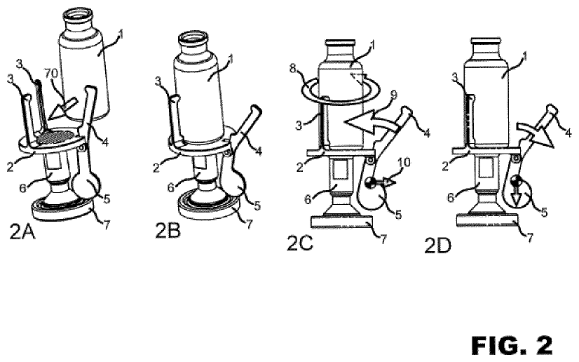

Now referring to FIG. 2A-2D, a spinner according to an embodiment of the invention is shown provided in four stages wherein FIG. 2A shows a perspective view illustrating the stage where a vial 1 is positioned on the support 2.

The spinner is preferably incorporated in the spin freezing module 72. In the shown embodiment of FIG. 2A, the vial 1 is being positioned on the support 2. The support comprises two fixed arms 3 connected to the support. A rotating arm 4, also coupled to the support 2, is shown in an outward position to allow the vial 1 to be brought into the support platform from the side. The two fixed arms 3 and the rotating arm 4 form a clamping mechanism. In the shown embodiment of FIG. 2B, the vial 1 is positioned onto the support 2, while the rotating arm 4 is in an open position. The rotating arm 4 is rotationally coupled to the support 2 via a hinge. The rotating arm 4 comprises a top portion, which is moved outwardly in the shown embodiment, and a bottom portion having a counterweight 5. The hinge is provided between the top portion and the bottom portion of the rotating arm 4. In the shown embodiment, the spinner further comprises a rotational axis 6, around which the spinner is rotated, and a sealed ball bearing 7, which is arranged to allow rotation of the spinner while sealing the spin-freeze module 72 from the outer environment. In the embodiment shown in FIG. 2C, the rotation 8 of the vial 1 is started through a drive, which is not shown, of the rotational axis 6. As shown, the centrifugal force acting on the counterweight 5 of the rotating arm 4 tilts the top portion of the rotating arm 4 inwards to clamp the vial. As shown in FIG. 2C, the centrifugal forces acts on the centre of gravity of the rotating arm 4, which is preferably positioned below the hinge. If the centre of gravity of the rotating arm 4 is positioned below the hinge, an increase of rotational velocity of the spinner will increase the gripping force on the vial. As shown, the counterweight 5 of the rotating arm 4 is pushed outward due to centrifugal force, resulting in the top portion of the rotating arm 4 to be pushed inwards. This leads to a force acting on the vial 1, pushing it towards, the fixed arms 3. The drive of the rotary axis 6, which is not shown, is located outside of the spin-freezing module 72 and the connection is made through a shaft with a sealed ball bearing 7. In FIG. 2D, the rotation of the spinner has stopped. The gravitational forces acting on the counterweight 5 lead the top portion of the rotating arm 4 to move away from the vial 1, thereby releasing it for further processing.

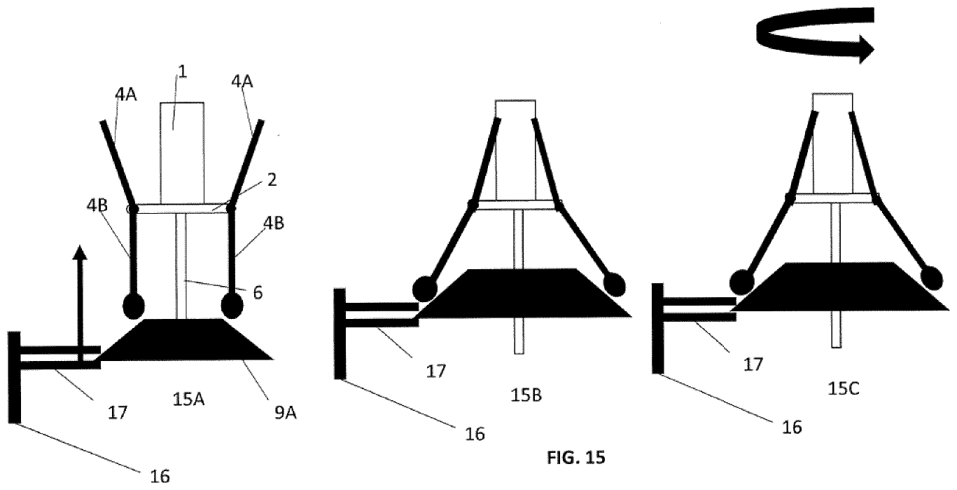

FIG. 15A-C shows a related embodiment where the top portion 4A of the one or more rotating arms 4 are slanted away when the spinner is stationary and the bottom parts 4B are slanted towards the support 2. In this stationary situation the vial 1 is easily removed and placed. To avoid undesired release of the vial 1 during ramp up of the rotation speed, a lock 9A can be added to the support that forces the counterweights in an outward direction prior to ramp up of the rotation speed. The lock 9A can comprise a slidable element with a slanted top surface, that can slide upwards in the direction of the support, such that the slanted top surface engages the bottom parts 4B. For example, as shown in FIG. 15A, the slidable element can move upwards along the axis of rotation 6 underneath the support 2 of the vial 1. Because of the slanted top surface of the slidable element, the bottom parts 4B are engaged at their resting position. Due to the upward sliding movement of the slidable element, the bottom parts 4B can be pushed in an outward direction towards a position slanted away from the rotation axis of the support such that the top portion of the one or more rotating arms engages or engages more with the vial. This position is shown in FIG. 15B. As an example, an optional lever 16 with fingers 17 can achieve the sliding movement of the slidable element or lock 9A. This sliding movement takes place during the stationary situation of the spinner. Before the spinning starts, the lever 16 is moved downwards to disengage with the sliding element, thus allowing the free rotation of the spinner axle. This position is shown in FIG. 15C. To prevent the slidable element from moving downwards at that point, the position of this slidable element is kept by frictional, magnetic or spring force (not shown). After spinning is finished, the lever 16 will engage with the sliding element while moving downward.

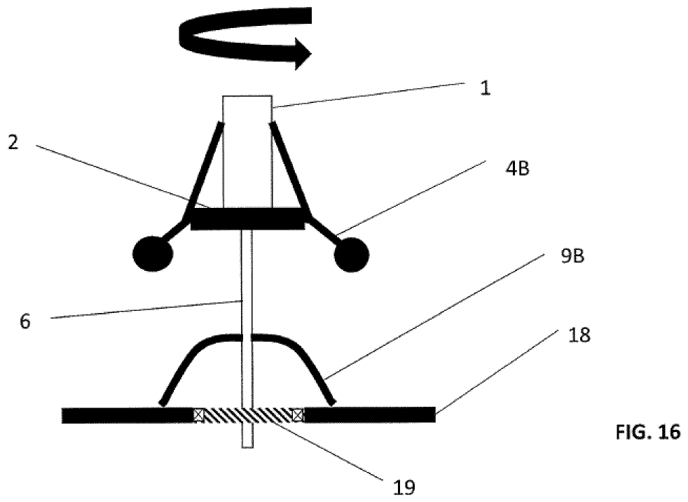

In a yet further preferred embodiment shown in FIG. 16, the section near the drive mechanism is shielded such that the flow of air cannot convectively disperse the generated particles. The shield 9B can for example be formed from stainless steel, PTFE, UHMPE and/or PEEK. Preferably, the shield has a rounded shape, e.g., a dome shape or umbrella shape, to achieve optimal flow of air least disturbed by the fast rotation of the axle. The dimensions of the shield can be such that the shield well extends over the dimensions of the particle source, for example the seal or bearing 19 that covers the direct air flow from the drive mechanism towards the support 2, such that the shield covers the direct air flow from the drive mechanism and the particle source towards the support 2. This further reduces the risk of particles ending up in the contents of the vial 1.

This shield 9B can be conveniently combined with the embodiment as described above where e.g. a lock 9A comprising a slidable element is used to engage the counterweights in a manner that the vial 1 is clamped in e.g. a stationary situation. For example, the shield provides a resting position for the slidable element when the slidable element does not engage the bottom parts 4B of the one or more rotating arms 4. In another embodiment, the slidable element can be configured in such a manner that the bottom surface of the slidable element forms the shield. The shield can be effective during the rotation of the spinner. After the rotation has started, the combined sliding element and shield can be moved towards the lower position. This means that the lever (16) as indicated in FIG. 15 can be moved downwards also, with minimal friction to the sliding element. This minimal friction can be achieved by making use of point contacts or by a choice of low-friction materials such as PTFE. This also can be achieved by rolling contacts such as small bearings.

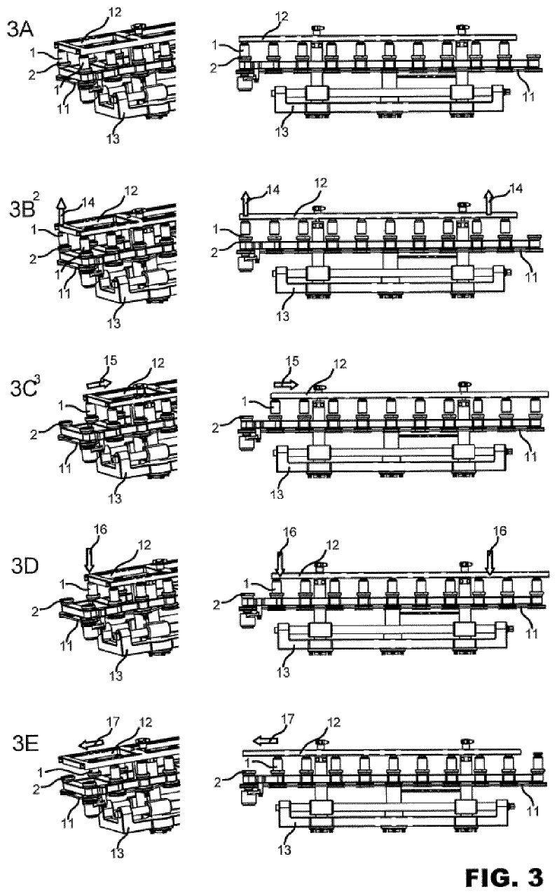

Now referring to FIG. 3A-3D, a transportation mechanism according to an embodiment of the invention is shown illustrating five steps of the transportation mechanism. The figures show the starting position of the transportation mechanism, the upward vertical movement of a walking beam, lifting the vials, the horizontal forward movement along the second axis of the walking beam bringing the vials to the next position, the downward vertical movement, putting the vials on the rotating platforms, and the horizontal backwards movement along the same second axis of the walking beam while leaving the vials in place. This shows the cyclic movement of the transport mechanism, which indexes the vials to their next position. The transportation mechanism is preferably provided in the sublimation module 77 and/or the desorption module 76.

In the shown embodiments, the transport mechanism comprises a walking beam 12, a plurality of rotating platforms 2, and a horizontal guiding mechanism 13. The transport mechanism further comprises drives to execute movements, which are not shown in this figure. The walking beam 12 comprises an elongated member having a recess extending over the entire length of the elongated member, wherein said recess defines two openings on opposing ends of the elongated member, and said recess further defining an open bottom surface of the elongated member, and wherein a cross-sectional shape of the elongated member comprises two lateral projections on opposing sides of the open bottom surface, said projections being arranged to engage with a neck portion of the vial 1, said walking beam 12 being arranged to move along a first vertical axis and along a second axis parallel to the elongated member to move at least one vial between the two or more rotating platforms.

FIG. 3A shows the starting position of the transportation mechanism. Here, the walking beam 12 is provided such that the neck portion of the vial 1 is provided in the recess of the walking beam through one of the two openings on opposing ends of the elongated member. In this position, the vials 1 rest on the rotating platforms 2, and are rotated so that they are heated in a substantially homogeneous manner. The rotating tables 2 are driven by a belt 11 provided underneath the rotating tables 2. This belt 11 connects all rotating platforms 2 to rotate the rotating platforms 2 at the same rotational velocity. To this end, the rotating platforms 2 are coupled to drive disks which are actuated by the belt 11. Preferably, the drive disks comprise a peripheral recess for receiving the belt 11 such that the belt 11 does not slip from the drive disks.

FIG. 3B shows the upward vertical movement 14 along the first vertical axis of a walking beam 12, lifting the vials 1. As the walking beam 12 is raised in a vertical movement 14, the lateral projections engage with the neck of the vial 1 to lift the vial 1 from the rotating platform 2. The vials 1 then stop rotating as they are lifted from the rotating platforms 2 and are engaged by the recess defined in the elongated member of the walking beam 12.

FIG. 3C shows the horizontal forward movement 15 along the second axis of the walking beam 12 bringing the vials 1 to the next position. Once the vials 1 are raised, the walking beam 12 may move the vials to the next position such that the vials 1 are moved from a first rotating platform 2 to a second rotating platform 2. The engagement of the vials with the lateral projections around the neck portion of the vial increases the stability of the vial during movement.

FIG. 3D shows the downward vertical movement 16, putting the vials 1 on the rotating platforms 2. Once the walking beam 12 positions the vials 1 above their required position, they may be lowered onto the rotating platforms 2. In an embodiment, the last vial 1 held by the elongated member of the walking beam 2 is positioned on a final platform which does not rotate. Alternatively, the last vial 1 is positioned on a final rotating platform where it will be retrieved by a vial handler 73 in accordance with any of the embodiments herein.

FIG. 3E shows the horizontal backwards movement 17 of the walking beam 12 while leaving the vials 1 in place. Once the vials 1 are positioned on their respective rotating platforms 2, the walking beam 12 is brought back into its original position, as shown in FIG. 3A. In the meanwhile, a new vial 1 may have been placed on the first rotating platform 2. In the shown embodiment of FIG. 3E, this has not been done to show the relative movement of the walking beam 12 more clearly. Since the downward vertical movement 16 shown in FIG. 3D releases the engagement of the vials 1 with the elongated member of the walking beam 12, the vials 1 can rotate freely on the rotating platforms 2. The elongated member of the walking beam 12 may then be brought back to its original position by moving along the horizontal backwards movement 17 along the second axis. This allows a vial handler 73 to pick the last vial 1 for further processing. As shown on the right side of FIG. 3E, the final vial is now no longer positioned in the recess of the elongated member such that it may be picked up from the platform for further processing.

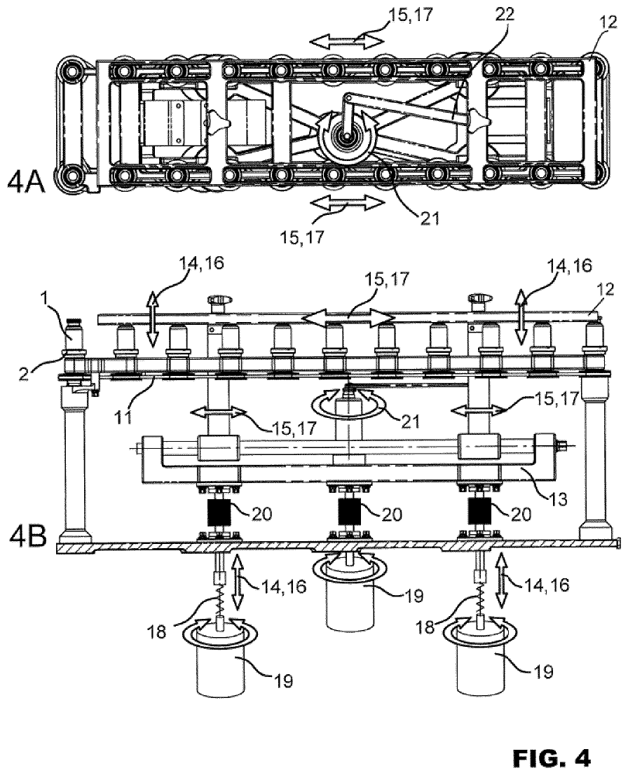

Now referring to FIG. 4, a transportation mechanism according to an embodiment of the invention is shown, illustrating a drive mechanism generating a movement of the transport mechanism. In particular, FIG. 4A shows a top view illustrating the drive mechanism to move the lift frame along the second axis, in two opposing horizontal directions 15, 17. The drive mechanism comprises a crankshaft mechanism to move the walking beam 12 along the second axis. The crankshaft mechanism comprises two rods, coupled to a rotating shaft. The rotation 21 of the shaft actuates the rods and moves the walking beam 12 backwards and forwards along the second axis.

FIG. 4B shows a side view illustrating the drive mechanism which allows horizontal and vertical displacement of the transportation mechanism. The movement of the elongated member of the walking beam 12 along the first vertical axis in a vertical direction 14, 16 is actuated by lift motors. The lift motors comprise a rotational drive 19 and a spindle mechanism 18 to actuate the walking beam 12 in a vertical direction 14, 16. The guide frame 13 transmits the movement along the first vertical axis to the walking beam 12 while simultaneously allowing for movement along the second axis in the horizontal directions 15, 17.

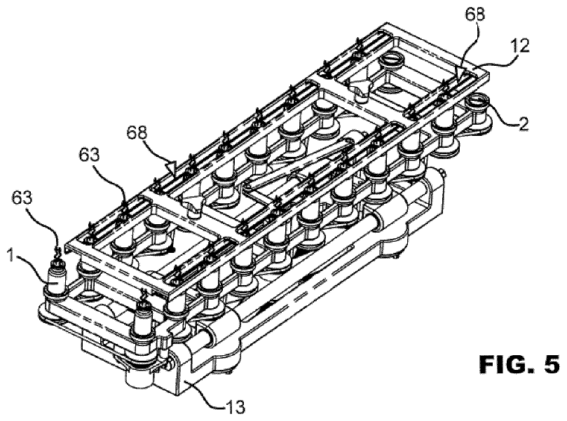

FIG. 5 shows a perspective view illustrating the free flow of vapour 63 from vials provided in the transport mechanism. The shown embodiment shows the transportation mechanism having two parallel elongated members to form the walking beam 12. The elongated members are provided with at least one opening 68 on a top surface, such that a passage is defined which extends through the elongated member. By providing such an opening 68 defining a passage, sublimed vapour from the liquid-containing substance can flow 68 upward during sublimation or desorption, without being trapped in the elongated member. In the shown embodiment, the opening 68 on the top surface is an elongated opening, extending over a width of a plurality of vials 1. Another benefit of the provision of such openings 68 to the walking beam 12 is that the risk of particles falling into the vial 1 during the transportation process is reduced.

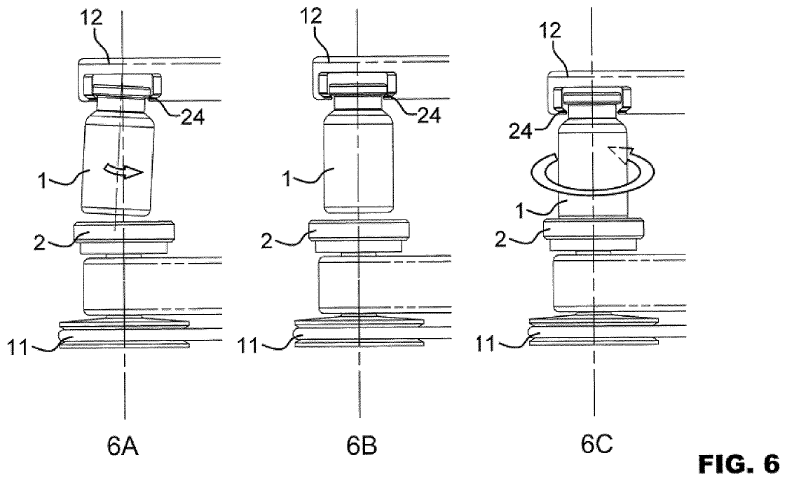

Now referring to FIG. 6, a side view is shown, illustrating self-alignment of the vial 1 provided in the transport mechanism. In particular, FIG. 6A shows a side view illustrating the vial aligning itself along a vertical axis. As the vial 1 is lifted from the rotating platform 2, it may be out of alignment with the centre of the recess provided in the elongated member of the walking beam 12. As the vial 1 is lifted from the rotating platform 2, a vertical centreline of the vial 1 may thus be out of alignment with a vertical centreline of the recess provided in the elongated member of the walking beam 12. As the vial 1 is lifted, the lateral projections, which engage with the neck portions of the vial 1, will straighten the vial 1. In the shown embodiment, the lateral projections have a chamfered top surface, which allows the vial 1 to attain a balanced position within the recess of the elongated member of the walking beam 12. The chamfered top surface of the lateral projections allows a raised portion of the neck portion of the vial 1 to slide down, while allowing a lowered portion of the neck portion of the vial to move upwards from the position shown in FIG. 6A. As such, the vial 1 is rotated such that the centreline of the vial 1 is aligned with a centreline of the recess of the elongated member of the walking beam 12 as shown in FIG. 6B. As the vial is positioned on the rotating platform 2, as shown in FIG. 6C, the alignment of the vial 1 reduces the risk on friction between the elongated member of the walking beam 12 and the vial 1. That is, the lateral projections of the elongated member to not touch the neck portion of the vial 1 while the vial 1 is rotating.

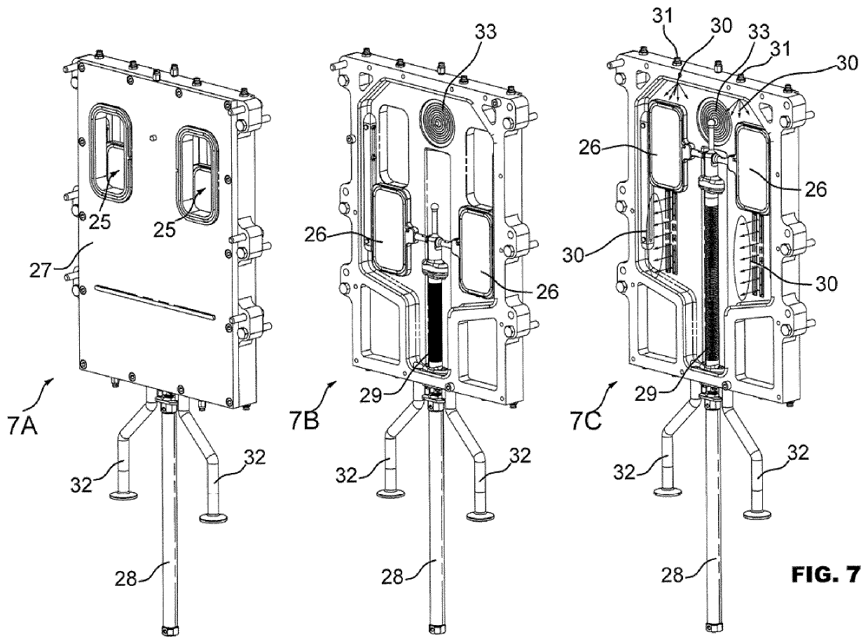

FIG. 7 shows a perspective view of a vacuum door according to an embodiment of the invention. In particular, FIG. 7A shows a perspective view of the vacuum door having a first panel 27, and a second opposing panel. A space is defined between the first 27 and the second panel. The two opposing panels have at least one opening 25, the opening 25 of the first panel 27 being located opposite the opening of the second panel, such that a vial 1 can be passed through the openings 25 to move through the vacuum door, wherein at least one sealing door 26 is provided in the space defined by the opposing panels 27, said sealing door 26 being moveable between a first position wherein the sealing door 26 is positioned in front of the openings 25, and a second position, wherein the sealing door 26 is positioned away from the openings 25, the vacuum door further comprising an actuation mechanism 33 for actuating the sealing door, said actuation mechanism 33 being arranged to move the sealing door 26 towards the first opening 25 or towards the second opening, when the sealing door 26 is in the first position. During transport of vials 1 from one module to another, the vials pass through the gate openings 25. The vacuum doors are preferably used in a load lock 74 for transporting the vials 1 between e.g. the infeed and filling module 71 and the spin-freezing module 71, and/or between the spin-freeze module 71 and the sublimation module 77, and/or between the sublimation module 77 and the desorption module 76 and/or between the desorption module 76 and the stoppering module 75.

FIG. 7B shows a cut-away view of the vacuum door, illustrating the inner parts of the vacuum door assembly wherein the sealing doors 26 are shown in the second position, such that they are positioned away from the openings 25. The sealing doors 26 are moved between the first and second positions by use of a pneumatic cylinder 28, said pneumatic cylinder 28 further comprising a bellows 29 provided around at least a part of a rod, said rod being attached to the sealing door 26. The pneumatic cylinder 28 is arranged to move the sealing doors 26 between the first and second positions by actuation of the rod. The bellows 29 provides separation of the clean area and the outer environment. This further reduces the risk of contamination of the liquid-containing composition in the vials 1.

Once the sealing doors 26 are in the first position, in front of the openings 25, the sealing doors may be moved towards the first opening or towards the second opening by an actuation mechanism 33. In the shown embodiment, this actuation mechanism is a bellows which is arranged to engage with an extended portion of the rod to push the doors towards the opening in the first or the second opposing panels to seal the vacuum door.

FIG. 7C shows a cut-away view of the vacuum door, illustrating the process conditions during the cleaning process. Once the sealing doors 26 are in the first position in front of the openings 25 in the panels, the vacuum doors may be cleaned. In the cleaning process, water with cleaning agents, or another liquid, is sprayed through nozzles and jets 30 to clean the space of the vacuum door. The water with cleaning agents is supplied through inlet ports 31.

The shown embodiment of the vacuum door further comprises two cleaning drains 32, which are arranged to allow a cleaning agent to be removed from the space of the vacuum door during cleaning.

The vacuum door is preferably used in a load lock 74. In such an embodiment, the load lock 74 comprises a transportation section comprising at least two vacuum doors, a first vacuum door being provided on a first side of the transportation section and a second vacuum door being provided in a second side of the transportation section, and said load lock further comprising at least two vial handlers 73, said vial handlers 73 being arranged to move vials 1 through the vacuum doors.

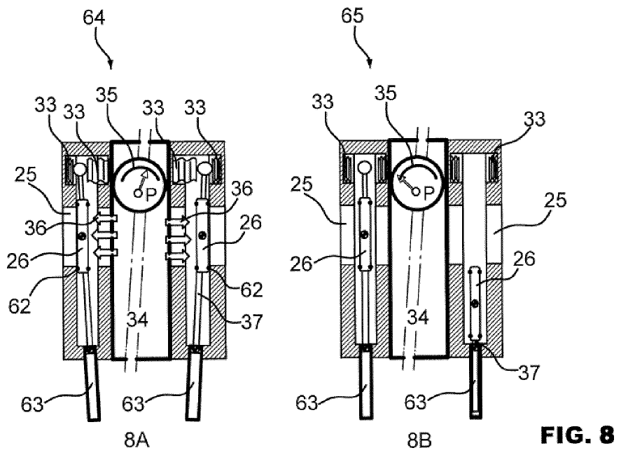

Now referring to FIG. 8 a cross-sectional view of a vacuum door coupled to a chamber 34 is shown. In particular, FIG. 8A illustrates a vacuum door coupled to a chamber 34 having a higher pressure than the adjacent module. The chamber 34 may be the transportation section of a load lock 74 but may also be e.g. the sublimation module 77, the desorption module 76, the stoppering module 75, the spin-freeze module 72 and/or the infeed and filling module 71.

As shown in FIG. 8A, the vacuum door comprises a space defined by two opposing panels having opposing openings 25 provided therein. The sealing door 26 is in the first position, in front of the openings 25. In the shown embodiment, the sealing door 26 is pressed towards a panel by the actuation mechanism 33 which is provided in the form of a bellows which is arranged to engage with an extended portion of the rod to push the doors towards the opening in the first panels to seal the vacuum door. The bellows is driven by pneumatics which forces the bellows 33 to move the sealing door 26 to snugly fit to the opening 25 and assure proper closure. In the event that the chamber 34 has a higher pressure than the adjacent module, the relative overpressure provides a further force on the sealing of the sealing door 26 and the opening 25. By controlling the positions of the bellows 33, the sealing doors 26 can be moved in the direction where closure is required. In the shown embodiment, the bellows 33 comprise a flexible membrane which is pneumatically actuated to move outwardly when pressurized.

The sealing door 26 comprises two peripheral seals 62 provided on a first and a second side of the sealing door 26, said peripheral seals 62 being arranged to engage with an seat region of the openings 25 provided around the periphery of the openings. These seals 62 are preferably flexible.

As shown in FIG. 8B, when the chamber 34 attains the same pressure as an adjacent module, and the bellows 33 does not engage with the rod to actuate the sealing door 26, the sealing door is positioned in the centre of the space defined by the opposing panels. In this configuration, the sealing door 26 can move up and down through the connection with a rod mechanism 63 without touching the opening 25. Further, FIG. 8B shows one sealing door 26 in the first position, in front of the opening 25 and one sealing door 26 in the second position where the opening 25 is free and a vial 1 may be moved through the door.

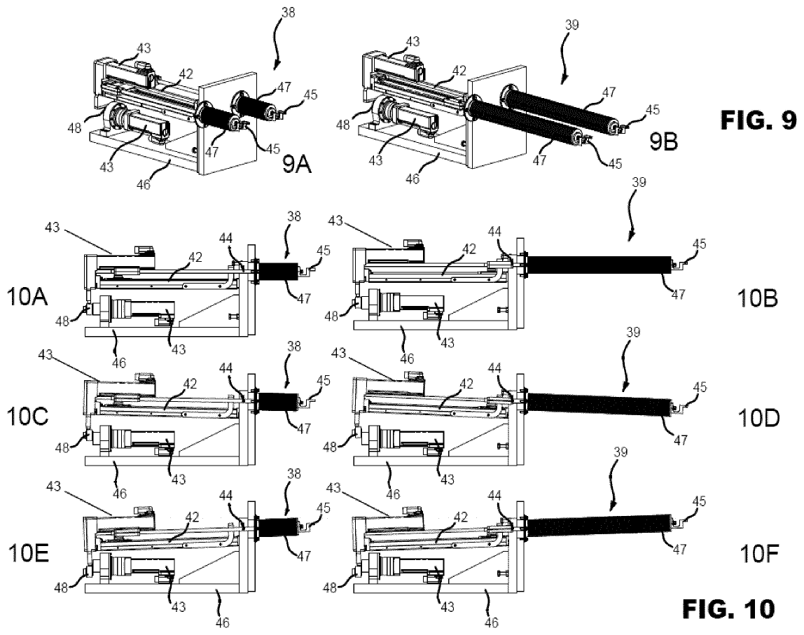

Now referring to FIG. 9 a perspective view of a vial handler 73 is shown according to an embodiment of the invention. In particular, FIG. 9A shows a vial handler 73 in a retracted position and FIG. 9B shows the vial handler 73 in an extended position. The vial handler 73 is arranged to transfer vials 1 from one location or module to another or from one module into a load lock and visa-versa. In an advantageous embodiment, the vial handler 73 is coupled to load locks 74 to transport vials 1 from one module to the next through a load lock 74. For example, the vial handler 73 may be used to transport vials 1 from the sublimation module 77 to the desorption module 76 through a load lock 74. A first vial handler 73 removes the vials 1 from the sublimation module 77 and into the transportation section of the load lock 74. A second vial handler 73 then moves the vials 1 from the transportation section of the load lock 74 to the desorption module 76. The vial handlers 73 are arranged to move the vials 1 both in horizontal and vertical way.

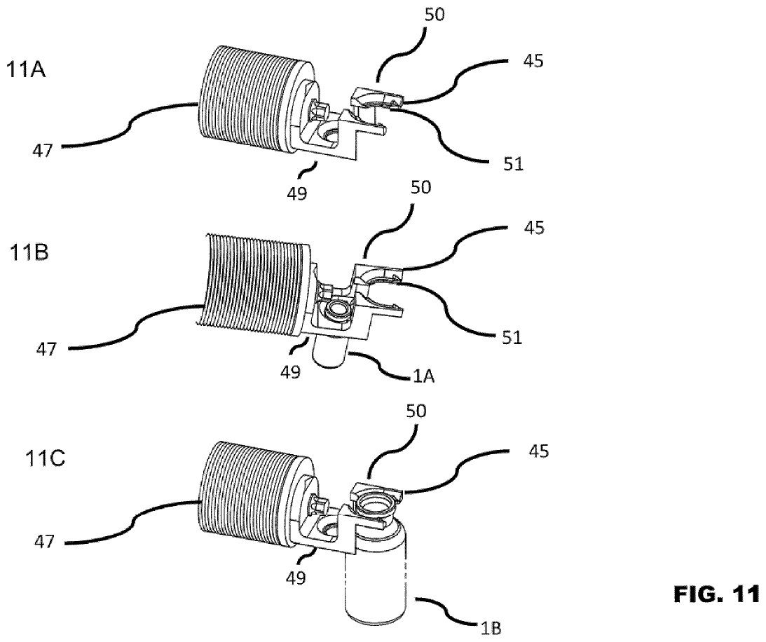

The horizontal translation of the vial handler 73 is shown in FIG. 9 whereas the vertical translation is shown in FIG. 10, which shows a side view of a vial handler according to an embodiment of the invention. In particular, FIG. 10A shows the vial handler in a retracted position without vertical displacement, FIG. 10B shows the vial handler in an extended position without vertical displacement, FIG. 10C shows the vial handler in a retracted position with downward vertical displacement, FIG. 10D shows the vial handler in an extended position with downward vertical displacement, FIG. 10E shows the vial handler in a retracted position with upward vertical displacement, FIG. 10F shows the vial handler in a retracted position with upward vertical displacement.

As shown in FIG. 9 and FIG. 10, the vial handler 73 comprises an elongated arm defining a distal end and a proximal end. The vial handler 73 further comprises a gripper 45 arranged to engage with a neck portion of a vial 1. The gripper 45 is provided on the distal end of the elongated arm. The elongated arm is provided through a barrier defining a pivot point 44, said pivot point 44 being positioned between the distal end and the proximal end of the elongated arm such that actuation in a plane orthogonal to the elongated arm of the proximal end of the elongated arm on a first side of the barrier translates to an opposite movement of the distal end of the arm on a second side of the barrier.

A plurality of actuators move the proximal end of the elongated arm. The movement between the retracted position and the extended position is effectuated by a linear guiding 42, actuated by a motor drive 43. The vials 1 are picked up and held by their neck portion in the gripper 45. The gripper 45 is mounted on the distal end of the elongated arm, which is surrounded by bellows 47 to protect the sterile environment from the outer environment.

The vertical movement of the distal end of the elongated arm is achieved by actuation of the proximal end of the elongated arm, on the other side of the barrier. The vertical movement is effectuated by another motor drive 43 with an eccentric wheel 48, which is coupled to the elongated arm. As the eccentric wheel 48 is driven by the motor drive, the proximal end of the elongated arm may be raised or lowered. As a result, the distal end and the gripper 45 are raised and/or lowered.

As shown in FIG. 10C and FIG. 10D, the eccentric wheel 48 is rotated such that the proximal end of the elongated arm is raised, leading to the lowering of the distal end of the elongated arm and the gripper 45. As shown, the effect of the movement of the proximal end of the elongated arm is dependent on the level of horizontal extension of the elongated arm.

The drives 43 arranged to actuate the horizontal and vertical movement of the elongated arm are provided on a frame 46. In a preferred embodiment, the frame is coupled to the barrier. The pivot point 44 comprises a leaf spring to allow the movement of the elongated arm while the bellows 47 remains coupled to the barrier. The bellows 47 is coupled to the barrier on one end and to the distal end of the elongated arm on the other end. As such, while the arm extends, the bellows 47 remains positioned around the distal end of the elongated arm to prevent the ingress of particles into the sterile environment from the outer environment.

Now referring to FIG. 11, a blow-out view is shown, illustrating a gripper 45 of the vial handler 73 according to an embodiment of the invention. In particular, FIG. 11A shows the gripper having a design with positions for two vial types. The gripper 45 is shown attached to the distal end of the elongated arm of the vial handler 73. The distal end of the elongated arm has a bellows 47 provided around the elongated arm. The gripper 45 of the shown embodiment comprises two portions in stepped relation to one another. A proximal portion 49 is arranged to receive a small vial 1 neck, where a distal portion 50 is arranged to receive a large vial 1 neck. FIG. 11B shows the gripper 45 having a small vial 1A in an engaged position and FIG. 11C shows the gripper 45 having a large vial 1B in an engaged position. If a vial 1 is too small to be engaged by the distal portion 50, it will pass through and be engaged by the proximal portion 49. As such, the two positions cover a large range of applicable vials 1, thus reducing the requirement for change-over when different vial sizes are applied. The distal portion 50 and the proximal portion 49 contain a rim 51 which prevents vials to fall off when horizontal and vertical movements are effectuated.

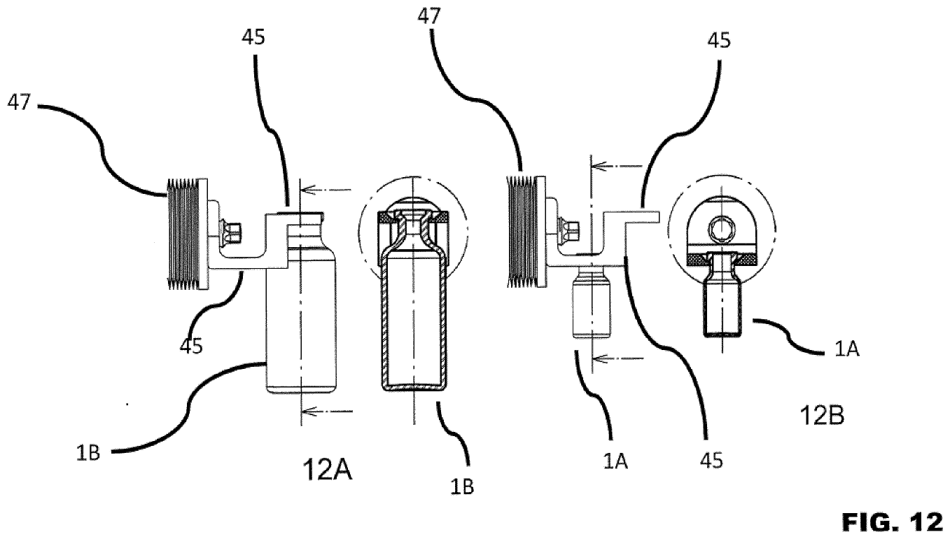

FIG. 12 shows a side view of the gripper 45 of the vial handler 73 where FIG. 12A shows the gripper 45 having a large vial 1B in an engaged position and FIG. 12B shows the gripper 45 having a small vial 1A in an engaged position. As shown in FIG. 12A, the large vial 1B is engaged by the distal portion 50 of the gripper 45 since it cannot move further into the gripper 45. The large vial 1B is supported by the rim 51. In FIG. 12B, the small vial 1A is engaged by the proximal portion 49 of the gripper 45 since it moved through the space defined by the distal portion 50 of the gripper 45.

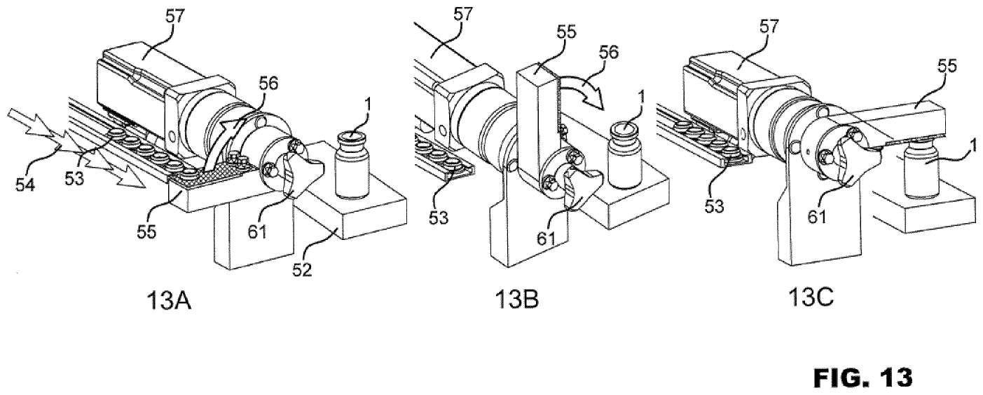

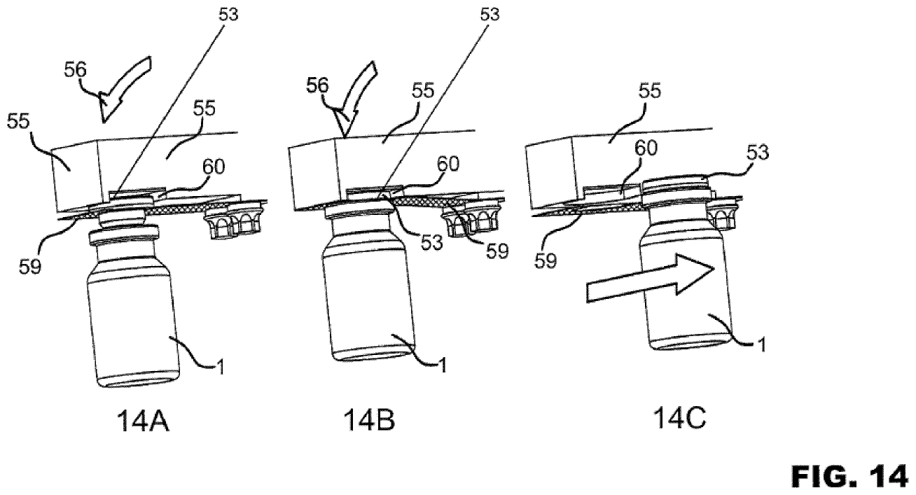

Now referring to FIG. 13, a perspective view of a stoppering system according to an embodiment of the invention is shown. In the shown embodiment, the stoppering system comprises a stopper holder 55 being rotatably attached to a substantially horizontal actuation axis at a first end. The horizontal actuation axis is driven by a rotation motor 57. The stopper holder 55 is rotationally moveable between a receiving position and a stoppering position by the actuation axis, which is driven by the rotation motor 57. The second end of the stopper holder 55 comprises a slot 60 at an edge region for receiving a stopper 53. The slot 60 has a lateral shape to receive the stopper 53 from the stopper feed. Upon receiving the stopper 53, it is contained in the slot 60 on a first side of the edge (slot 60 is shown in FIG. 14). The slot further defines an opening for engaging the stopper 53 with a vial 1 on a second side of the edge, wherein in the receiving position the opening is directed upwards, and wherein in the stoppering position the opening is directed downwards. The slot 60 is formed such that the stopper 53 is held in the slot 60 in the stoppering position.

In FIG. 13A, a feed of stoppers 53 is shown which lead to the slot 60 in the stopper holder 55 when it is in a receiving position. Through a controlled movement control system, which is not shown, stoppers 53 are only pushed when the stopper holder 55 in the receiving position and is not provided with a stopper 53. In the meanwhile, a vial 1 is positioned on a support platform 52, waiting for the stoppering to occur.

FIG. 13B shows the rotation of the stopper holder 55 from a receiving position to a stoppering position. Once the stopper 53 is provided in the opening 60 of the stopper holder 55, the stopper holder 55 may be rotated 56 around the actuation axis. This brings the stopper 53 towards the vial 1.

FIG. 13C shows the stopper holder 55 in the stoppering position. In this position, the stopper holder 55 exerts a force on the vial 1 which is standing on a the support platform 52. To allow for different vial sizes the stopper holder 55 can be exchanged by dismounting the stopper holder from the actuation axis using the knob 61.

Now referring to FIG. 14, a blow-out view of a stoppering system according to an embodiment of the invention is shown, where FIG. 14A shows a stopper holder 55 positioning a stopper 53 near the neck of a vial 1, FIG. 14B shows a stopper 53 being pushed into the neck of a vial 1, and FIG. 14C shows the vial 1 with the stopper 53 being released from the stopper holder 55.

In the shown embodiment, a flexible plate 59 is provided on the stopper holder 55. The flexible plate 59 is arranged over the opening defined by the slot 60. The flexible plate 59 has an opening corresponding with the opening defined by the slot 60 but the opening on the flexible plate 59 is smaller than the opening defined by the slot 60. As a result, the stopper 53 is maintained in the slot 60 and rests on the flexible plate 59 when the stopper holder 55 is in the stoppering position. By providing a flexible plate 59, the stopper 53 is kept in place during the movement of the stopper holder 55 from the receiving position to the stoppering position.

The use of such a flexible plate 59 allows slight deformation to press the stopper 53 into the vial 1 to an increased extent. As shown in FIG. 14B, the flexible plate 59 is deformed as the stopper 53 is pressed into the vial 1. As the stoppers 53 are pressed into the vial 1 further, the quality of the primary closure is increased.

As shown in FIG. 14C, once the stopper 53 is pressed into the vial 1, the vial may be removed from underneath the stopper holder 55.

The figures are intended for illustrative purposes only, and do not serve as restriction of the scope or the protection as laid down by the claims.

Two or more of the above embodiments may be combined in any appropriate manner as is also shown in FIG. 1.

The invention is further exemplified by the following clauses.

Clause 1: A transportation mechanism for use in a device for freeze-drying a liquid-containing composition in a continuous process, the transportation mechanism comprising: two or more rotating platforms for receiving and rotating vials; and a walking beam, said walking beam comprising an elongated member having a recess extending over the entire length of the elongated member, wherein said recess defines two openings on opposing ends of the elongated member, and said recess further defining an open bottom surface of the elongated member, and wherein a cross-sectional shape of the elongated member comprises two lateral projections on opposing sides of the open bottom surface, said projections being arranged to engage with a neck portion of the vial, said walking beam being arranged to move along a first vertical axis and along a second axis parallel to the elongated member to move at least one vial between the two or more rotating platforms.

Clause 2: The transportation mechanism of clause 1, wherein the lateral projections are provided with a chamfered top surface, preferably wherein the lateral projections extend continuously along the entire length of the elongated member, preferably wherein the elongated member is further provided with at least one opening on a top surface, such that an passage is defined through the elongated member.

Clause 3: The transportation mechanism of any of clauses 1-2, wherein the rotating platforms are provided with an upwardly directed rim along the periphery of the rotating platform, preferably wherein the rotating platforms are coupled to drive disks, said drive disks preferably being actuated by a belt, more preferably wherein a single belt extends over all drive disks to rotate all rotating platforms at the same rotational velocity.

Clause 4: A vial handler for use in a device for freeze-drying a liquid-containing composition in a continuous process, said vial handler comprising: an elongated arm defining a distal end and a proximal end; and a gripper arranged to engage with a neck portion of a vial, said gripper being provided on the distal end of the elongated arm, wherein the elongated arm is provided through a barrier defining a pivot point, said pivot point being positioned between the distal end and the proximal end of the elongated arm such that actuation of the proximal end of the elongated arm in a plane orthogonal to the elongated arm on a first side of the barrier translates to an opposite movement of the distal end of the arm on a second side of the barrier.

Clause 5: The vial handler of clause 4, the gripper comprises two forwardly projecting legs, said legs having a reducing thickness moving away from the distal end of the arm, such that the legs have an increasing width moving away from the distal end of the arm, preferably wherein the reach of the elongated arm, along the direction of the elongated arm, during extension of the elongated arm, is at least about 150 mm, preferably at least about 200 mm, more preferably at least about 250 mm, still more preferably at least about 300 mm.

Clause 6: The vial handler of clause 4 or 5, containing at least 2 grippers, preferably at least 5 grippers, more preferably at least 10 grippers.

Clause 7: A vacuum door for use in a device for freeze-drying a liquid-containing composition in a continuous process, said vacuum door comprising: a first panel; and a second opposing panel, defining a space therebetween, said two opposing panels having at least one opening, the opening of the first panel being located opposite the opening of the second panel, such that a vial can be passed through the openings to move through the vacuum door, wherein at least one sealing door is provided in the space defined by the opposing panels, said sealing door being moveable between a first position wherein the sealing door is positioned in front of the openings, and a second position, wherein the sealing door is positioned away from the openings, the vacuum door further comprising an actuation mechanism for actuating the sealing door, said actuation mechanism being arranged to move the sealing door towards the first opening or towards the second opening, when the sealing door is in the first position.

Clause 8: The vacuum door of clause 7, wherein the sealing door comprises two peripheral seals, preferably flexible seals, provided on a first and a second side of the sealing door, said peripheral seals being arranged to engage with an seat region of the openings provided around the periphery of the openings.

Clause 9: The vacuum door of clause 7 or 8, wherein the vacuum door further comprises a pneumatic cylinder provided in the space defined by the two opposing panels, said pneumatic cylinder comprising a bellows provided around at least a part of a rod, said rod being attached to the sealing door, wherein the pneumatic cylinder is arranged to move the sealing doors between the first and second position, preferably wherein the actuation mechanism comprises at least one bellows actuator, provided in the first or second panel, said bellows actuator being arranged to engage with the rod to move the sealing door towards the opening in the first or the second panel, more preferably wherein the bellows actuator comprises a circular membrane, having an engagement surface provided in the middle of the membrane, wherein the membrane is arranged to project outwardly such that the engagement surface is moved outwardly.

Clause 10: A load lock for use in a device for freeze-drying a liquid-containing composition in a continuous process, said load lock comprising: a transportation section; and a first and a second vacuum door according to any of clauses 7-9; the first vacuum door being provided on a first side of the transportation section and the second vacuum door being provided in a second side of the transportation section, and said load lock further comprising at least two vial handlers, preferably vial handlers according to any of clauses 4-6, said vial handlers being arranged to move vials through the vacuum doors.

Clause 11: A spinner for use in a device for freeze-drying a liquid-containing composition in a continuous process, said spinner comprising: a support for supporting a vial; and a clamping mechanism connected to the support, wherein the clamping mechanism comprises at least two arms coupled to the support, wherein at least one of the arms is a rotating arm being rotationally coupled to the support via a hinge, wherein the rotating arm comprises a top portion and a bottom portion having a counterweight, said hinge being provided between said top portion and said bottom portion.

Clause 12: The spinner according to clause 11, wherein the gravitational centre of the rotating arm is positioned below the hinge, preferably wherein the moment of the bottom portion is more than 10% larger than the moment of the top portion, preferably between 20-100% larger than the moment of the top portion, more preferably between about 20-50% larger than the moment of the top portion.

Clause 13: The spinner according to clause 11 or 12, wherein the rotating arm has a balanced position, when the spinner is stationary, and wherein the bottom portion is slanted towards the support, while the top portion is slanted away from the support.

Clause 14: A stoppering system for use in a device for freeze-drying a liquid-containing composition in a continuous process, said stoppering system comprising: a stopper holder; and a horizontal actuation axis, said stopper holder being rotatably attached to the horizontal actuation axis at a first end, said stopper holder being moveable between a receiving position and a stoppering position by the actuation axis, wherein the second end of the stopper holder comprises a slot at an edge region for receiving a stopper, said slot having a lateral shape to receive the stopper such that the stopper may be contained in the slot on a first side of the edge, and an opening for engaging the stopper with a vial on a second side of the edge, wherein in the receiving position the opening is directed upwards, and wherein in the stoppering position the opening is directed downwards, wherein the slot is formed such that the stopper is held in the slot in the stoppering position.

Clause 15: The stoppering system according to clause 14, wherein a flexible plate is provided on the stopper holder, said flexible plate being arranged over the opening defined by the slot, and said flexible plate having an opening corresponding with the opening defined by the slot, the opening on the flexible plate being smaller than the opening defined by the slot, such that the stopper is maintained in the slot.

Clause 15: A device for freeze-drying a liquid containing composition in a continuous process, said device comprising one or more, preferably three or more, of: a transportation mechanism according to any of clauses 1-3; a vial handler according to any of clauses 4-6;
a vacuum door according to any of clauses 7-9, preferably wherein the vacuum door forms part of a load lock according to clause 10; a spinner according to any of clauses 11-13; and a stoppering system according to any of clauses 14-15, preferably wherein the device comprises at least the transportation mechanism, the vial handler, and the vacuum door, more preferably wherein the device is able to process at least about 5000 vials per day.

1. A transportation mechanism for use in a device for freeze-drying a liquid-containing composition in a continuous process, the transportation mechanism comprising:
two or more platforms for receiving vials; and
a walking beam, said walking beam comprising an elongated member having an at least partly open bottom surface, and
wherein a cross-sectional shape of the elongated member comprises two lateral projections on opposing sides of the at least partly open bottom surface, said projections being arranged to engage with a neck portion of the vial, said walking beam being arranged to move along a first vertical axis and along a second axis parallel to the elongated member to move at least one vial between the two or more platforms.

2. The transportation mechanism of claim 1, wherein the lateral projections extend along the entire length of the elongated member.

3. The transportation mechanism of claim 1, wherein the at least partly open bottom surface is defined by a recess of the elongated member extending over the entire length of the elongated member.

4. The transportation mechanism of any one of claim 1, wherein the elongated member comprises two openings on opposing ends of the elongated member, suitable for admitting at least the to be engaged neck portion of the vial.

5. The transportation mechanism of claim 4, wherein the two openings are formed in the bottom surface and/or at least one of a side surface of the elongated member.

6. The transportation mechanism of claim 1, wherein the lateral projections are provided with a chamfered top surface.

7. The transportation mechanism of claim 1, wherein the elongated member is further provided with at least one opening on a top surface, such that an passage is defined through the elongated member.

8. The transportation mechanism of claim 1, wherein the platforms are provided with an upwardly directed rim along the periphery of the platform.

9. The transportation mechanism of claim 1, wherein the walking beam comprises two or more elongated members provided substantially parallel to each other.

10. The transportation mechanism of claim 1, wherein the movement of the elongated member along the first vertical axis is actuated by one or more lift motors; and/or
wherein the movement of the elongated member along the second axis is actuated by a crankshaft mechanism.

11. The transportation mechanism of claim 1, wherein the platforms are rotating platforms for rotating vials.

12. The transportation mechanism of claim 11, wherein the rotating platforms are coupled to drive disks,
wherein said drive disks are actuated by a belt; and/or
wherein said drive disks are actuated by magnetic couplings to rotate the rotating platforms.

13. A module, wherein the module is a sublimation and/or desorption module, comprising the transportation mechanism according to claim 1, wherein the module comprises an array of infrared radiators along a length of the module.

14. A device for freeze-drying a liquid containing composition in a continuous process, said device comprising a transportation mechanism according to claim 1.

15. A method for transporting a plurality of vials, each vial being respectively transported at the same time from a start platform for that vial to an end platform for that vial, wherein the start platforms are different for each vial and wherein the end platforms are different for each vial;
the method comprising:
engaging with a neck portion of each vial at its start platform;
performing an upward vertical movement of each vial; performing a horizontal movement of each vial, such that each vial is above its end platform;
performing a downward vertical movement of each vial so that each vial is placed on its end platform; and
disengaging with the neck portion of each vial at its end platform.
